(19) United States
(12) Patent Application Publication
(10) Pub. No.: US 2026/0304453 A1
(43) Pub. Date: Oct. 1, 2026

(54) FREQUENCY RESOURCE ALLOCATION FOR NON-CONTIGUOUS SUBCHANNELS IN SIDELINK COMMUNICATIONS

(71) Applicant: QUALCOMM Incorporated, San Diego, CA (US)

(72) Inventors: Shaozhen GUO, Beijing (CN); Changlong XU, Beijing (CN); Chih-Hao LIU, San Diego, CA (US); Jing SUN, San Diego, CA (US); Siyi CHEN, Beijing (CN); Luanxia YANG, Beijing (CN); Giovanni CHISCI, San Diego, CA (US); Xiaoxia ZHANG, San Diego, CA (US); Hao XU, Beijing (CN)

(21) Appl. No.: 19/478,618

(22) PCT Filed: Jul. 7, 2023
(86) PCT No.: PCT/CN2023/106250

§ 371 Date: Oct. 24, 2025

(51) Int. Cl. H04W 72/25; H04L 5/00

(52) U.S. Cl. CPC H04W 72/25; H04L 5/0094

(57) ABSTRACT

Methods, systems, and devices for wireless communication are described. In some examples, a user equipment (UE) may receive control signaling that indicates a frequency resource allocation for at least a first sidelink resource and a second sidelink resource, where the frequency resource allocation may indicate a non-contiguous subchannel combination for the second sidelink resource. In response to receiving the control signaling, the UE may select the non-contiguous subchannel combination for the second sidelink resource based on a mapping between an index value of the frequency resource allocation and multiple subchannel combinations. The UE may also select a subchannel combination for the first sidelink resource based on a relationship between the first sidelink resource and the second sidelink resource. In response to selecting the subchannel combinations for the first and second sidelink resources, the UE may communicate via a sidelink channel using the first sidelink resource and the second sidelink resource.

### CROSS REFERENCE

The present Application for Patent is a 371 national phase filing of International Patent Application No. PCT/CN2023/106250 by GUO et al., entitled “FREQUENCY RESOURCE ALLOCATION FOR NON-CONTIGUOUS SUBCHANNELS IN SIDELINK COMMUNICATIONS,” filed Jul. 7, 2023, assigned to the assignee hereof, and expressly incorporated by reference herein.

### FIELD OF TECHNOLOGY

The following relates to wireless communications, including frequency resource allocation for non-contiguous subchannels in sidelink communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support frequency resource allocation for non-contiguous subchannels in sidelink communications. For example, the described techniques provide for a first user equipment (UE) to receive, and for a network entity or a second UE to transmit, non-contiguous subchannel allocations for multiple sidelink resources, thereby enabling increased transmission power in sidelink communications. For example, the first UE may receive, and the network entity or the second UE may transmit, control signaling that indicates a frequency resource allocation for at least a first sidelink resource and a second sidelink resource, where the frequency resource allocation may indicate a non-contiguous subchannel combination for the second sidelink resource. In response to receiving the control signaling, the first UE may select the non-contiguous subchannel combination for the second sidelink resource based on a mapping between an index value of the frequency resource allocation and multiple subchannel combinations. The first UE may also select a subchannel combination for the first sidelink resource based on a relationship between the first sidelink resource and the second sidelink resource. In response to selecting the subchannel combinations for the first and second sidelink resources, the first UE and the second UE may communicate via a sidelink channel using the first sidelink resource and the second sidelink resource.

A method for wireless communications by a UE is described. The method may include receiving control signaling that indicates a frequency resource allocation for multiple sidelink resources, the multiple sidelink resources including at least a first sidelink resource and a second sidelink resource, where the frequency resource allocation indicates a non-contiguous subchannel combination for the second sidelink resource of the multiple sidelink resources and communicating via a sidelink channel using at least the first sidelink resource and the second sidelink resource of the multiple sidelink resources, where a subchannel combination for the first sidelink resource is based on a relationship between the first sidelink resource and the second sidelink resource and on a quantity of the multiple sidelink resources.

A UE for wireless communication is described. The UE may include one or more memories storing processor-executable code and one or more processors coupled with the one or more memories and individually or collectively operable to execute the code to cause the UE to receive control signaling that indicates a frequency resource allocation for multiple sidelink resources, the multiple sidelink resources including at least a first sidelink resource and a second sidelink resource, where the frequency resource allocation indicates a non-contiguous subchannel combination for the second sidelink resource of the multiple sidelink resources and communicate via a sidelink channel using at least the first sidelink resource and the second sidelink resource of the multiple sidelink resources, where a subchannel combination for the first sidelink resource is based on a relationship between the first sidelink resource and the second sidelink resource and on a quantity of the multiple sidelink resources.

Another UE for wireless communication is described. The UE may include means for receiving control signaling that indicates a frequency resource allocation for multiple sidelink resources, the multiple sidelink resources including at least a first sidelink resource and a second sidelink resource, where the frequency resource allocation indicates a non-contiguous subchannel combination for the second sidelink resource of the multiple sidelink resources and means for communicating via a sidelink channel using at least the first sidelink resource and the second sidelink resource of the multiple sidelink resources, where a subchannel combination for the first sidelink resource is based on a relationship between the first sidelink resource and the second sidelink resource and on a quantity of the multiple sidelink resources.

A non-transitory computer-readable medium storing code for wireless communications is described. The code may include instructions executable by one or more processors to receive control signaling that indicates a frequency resource allocation for multiple sidelink resources, the multiple sidelink resources including at least a first sidelink resource and a second sidelink resource, where the frequency resource allocation indicates a non-contiguous subchannel combination for the second sidelink resource of the multiple sidelink resources and communicate via a sidelink channel using at least the first sidelink resource and the second sidelink resource of the multiple sidelink resources, where a subchannel combination for the first sidelink resource is based on a relationship between the first sidelink resource and the second sidelink resource and on a quantity of the multiple sidelink resources.

Some examples of the method, UEs, and non-transitory computer-readable medium described herein may further include operations, features, means, or instructions for selecting the non-contiguous subchannel combination for the second sidelink resource based on an index value associated with the frequency resource allocation.

Some examples of the method, UEs, and non-transitory computer-readable medium described herein may further include operations, features, means, or instructions for mapping the index value associated with the frequency resource allocation to one of a set of multiple subchannel combinations, where selecting the non-contiguous subchannel combination for the second sidelink resource may be based on mapping the index value to one of the set of multiple subchannel combinations.

Some examples of the method, UEs, and non-transitory computer-readable medium described herein may further include operations, features, means, or instructions for selecting the non-contiguous subchannel combination for the second sidelink resource as the subchannel combination for the first sidelink resource, where the relationship between the second sidelink resource and the first sidelink resource includes the non-contiguous subchannel combination for the second sidelink resource being applied to each of the multiple sidelink resources.

Some examples of the method, UEs, and non-transitory computer-readable medium described herein may further include operations, features, means, or instructions for selecting a second non-contiguous subchannel combination as the subchannel combination for the first sidelink resource, where the relationship between the second sidelink resource and the first sidelink resource includes that each of the multiple sidelink resources may be associated with a respective non-contiguous subchannel combination.

Some examples of the method, UEs, and non-transitory computer-readable medium described herein may further include operations, features, means, or instructions for selecting the second non-contiguous subchannel combination for the first sidelink resource may be based on a starting subchannel index of a physical sidelink control channel (PSCCH) and a defined offset.

Some examples of the method, UEs, and non-transitory computer-readable medium described herein may further include operations, features, means, or instructions for calculating a difference between a first index of a first subchannel of the non-contiguous subchannel combination for the second sidelink resource and a second index of a second subchannel of the non-contiguous subchannel combination for the second sidelink resource, where the defined offset may be based on the difference.

Some examples of the method, UEs, and non-transitory computer-readable medium described herein may further include operations, features, means, or instructions for receiving, via the control signaling, an indication of the defined offset.

Some examples of the method, UEs, and non-transitory computer-readable medium described herein may further include operations, features, means, or instructions for selecting the second non-contiguous subchannel combination may be based on a starting subchannel index of a PSCCH and a quantity of subchannels indicated via the frequency resource allocation.

In some examples of the method, UEs, and non-transitory computer-readable medium described herein, the second non-contiguous subchannel combination may have a same starting subchannel index of the PSCCH and a same quantity of subchannels as the non-contiguous subchannel combination for the second sidelink resource.

Some examples of the method, UEs, and non-transitory computer-readable medium described herein may further include operations, features, means, or instructions for receiving, via the control signaling, an indication of the second non-contiguous subchannel combination for the first sidelink resource, where the second non-contiguous subchannel combination may be selected based on the indication.

In some examples of the method, UEs, and non-transitory computer-readable medium described herein, the subchannel combination for the first sidelink resource may be a contiguous subchannel combination.

Some examples of the method, UEs, and non-transitory computer-readable medium described herein may further include operations, features, means, or instructions for receiving, via the control signaling, an indication of the contiguous subchannel combination.

In some examples of the method, UEs, and non-transitory computer-readable medium described herein, the contiguous subchannel combination may be based on a starting subchannel index of a PSCCH and a quantity of subchannels indicated via the frequency resource allocation.

Some examples of the method, UEs, and non-transitory computer-readable medium described herein may further include operations, features, means, or instructions for selecting the non-contiguous subchannel combination for the second sidelink resource may be further based on a starting subchannel index of a PSCCH.

Some examples of the method, UEs, and non-transitory computer-readable medium described herein may further include operations, features, means, or instructions for selecting the non-contiguous subchannel combination for the second sidelink resource may be further based on a quantity of subchannels for the second sidelink resource and a quantity of subchannel indexes of the non-contiguous subchannel combination for the second sidelink resource.

In some examples of the method, UEs, and non-transitory computer-readable medium described herein, a quantity of bits of the index value of the frequency resource allocation may be based on a quantity of a set of multiple contiguous subchannel combinations for the multiple sidelink resources and a quantity of a set of multiple non-contiguous subchannel combinations for the multiple sidelink resources.

A method for wireless communications by a UE is described. The method may include transmitting control signaling that indicates a frequency resource allocation for multiple sidelink resources, the multiple sidelink resources including at least a first sidelink resource and a second sidelink resource, where the frequency resource allocation indicates a non-contiguous subchannel combination for the second sidelink resource of the multiple sidelink resources and communicating via a sidelink channel using at least the first sidelink resource and the second sidelink resource of the multiple sidelink resources, where a subchannel combination for the first sidelink resource is based on a relationship between the second sidelink resource and the first sidelink resource and on a quantity of the multiple sidelink resources.

A UE for wireless communication is described. The UE may include one or more memories storing processor-executable code and one or more processors coupled with the one or more memories and individually or collectively operable to execute the code to cause the UE to transmit control signaling that indicates a frequency resource allocation for multiple sidelink resources, the multiple sidelink resources including at least a first sidelink resource and a second sidelink resource, where the frequency resource allocation indicates a non-contiguous subchannel combination for the second sidelink resource of the multiple sidelink resources and communicate via a sidelink channel using at least the first sidelink resource and the second sidelink resource of the multiple sidelink resources, where a subchannel combination for the first sidelink resource is based on a relationship between the second sidelink resource and the first sidelink resource and on a quantity of the multiple sidelink resources.

Another UE for wireless communication is described. The UE may include means for transmitting control signaling that indicates a frequency resource allocation for multiple sidelink resources, the multiple sidelink resources including at least a first sidelink resource and a second sidelink resource, where the frequency resource allocation indicates a non-contiguous subchannel combination for the second sidelink resource of the multiple sidelink resources and means for communicating via a sidelink channel using at least the first sidelink resource and the second sidelink resource of the multiple sidelink resources, where a subchannel combination for the first sidelink resource is based on a relationship between the second sidelink resource and the first sidelink resource and on a quantity of the multiple sidelink resources.

A non-transitory computer-readable medium storing code for wireless communications is described. The code may include instructions executable by one or more processors to transmit control signaling that indicates a frequency resource allocation for multiple sidelink resources, the multiple sidelink resources including at least a first sidelink resource and a second sidelink resource, where the frequency resource allocation indicates a non-contiguous subchannel combination for the second sidelink resource of the multiple sidelink resources and communicate via a sidelink channel using at least the first sidelink resource and the second sidelink resource of the multiple sidelink resources, where a subchannel combination for the first sidelink resource is based on a relationship between the second sidelink resource and the first sidelink resource and on a quantity of the multiple sidelink resources.

In some examples of the method, UEs, and non-transitory computer-readable medium described herein, the non-contiguous subchannel combination for the second sidelink resource may be based on an index value of the frequency resource allocation.

In some examples of the method, UEs, and non-transitory computer-readable medium described herein, the subchannel combination for the first sidelink resource may be equivalent to the non-contiguous subchannel combination for the second sidelink resource.

In some examples of the method, UEs, and non-transitory computer-readable medium described herein, the non-contiguous subchannel combination for the second sidelink resource may be further based on a starting subchannel index of a PSCCH.

In some examples of the method, UEs, and non-transitory computer-readable medium described herein, the relationship between the second sidelink resource and the first sidelink resource includes the subchannel combination of the first sidelink resource being non-contiguous and being different from the non-contiguous subchannel combination of the second sidelink resource.

In some examples of the method, UEs, and non-transitory computer-readable medium described herein, a second non-contiguous subchannel combination for the first sidelink resource may be based on a starting subchannel index of a PSCCH and a defined offset.

In some examples of the method, UEs, and non-transitory computer-readable medium described herein, the defined offset may be a difference between a first index of a first subchannel of the non-contiguous subchannel combination for the second sidelink resource and a second index of a second subchannel of the non-contiguous subchannel combination for the second sidelink resource, and an offset of the second non-contiguous subchannel combination for the first sidelink resource may be equivalent to the defined offset.

Some examples of the method, UEs, and non-transitory computer-readable medium described herein may further include operations, features, means, or instructions for transmitting, via the control signaling, an indication of the defined offset.

In some examples of the method, UEs, and non-transitory computer-readable medium described herein, a second non-contiguous subchannel combination may be based on a starting subchannel index of a PSCCH and a quantity of subchannels indicated via the frequency resource allocation.

In some examples of the method, UEs, and non-transitory computer-readable medium described herein, the second non-contiguous subchannel combination for the first sidelink resource may have a same starting subchannel index of the PSCCH and a same quantity of subchannels as the non-contiguous subchannel combination for the second sidelink resource.

Some examples of the method, UEs, and non-transitory computer-readable medium described herein may further include operations, features, means, or instructions for transmitting, via the control signaling, an indication of the second non-contiguous subchannel combination for the first sidelink resource.

In some examples of the method, UEs, and non-transitory computer-readable medium described herein, the subchannel combination for the first sidelink resource may be a contiguous subchannel combination.

Some examples of the method, UEs, and non-transitory computer-readable medium described herein may further include operations, features, means, or instructions for transmitting, via the control signaling, an indication of the contiguous subchannel combination.

In some examples of the method, UEs, and non-transitory computer-readable medium described herein, the contiguous subchannel combination may be based on a starting subchannel index of a PSCCH and a quantity of subchannels indicated via the frequency resource allocation.

In some examples of the method, UEs, and non-transitory computer-readable medium described herein, the non-contiguous subchannel combination for the second sidelink resource may be further based on a starting subchannel index of a PSCCH.

In some examples of the method, UEs, and non-transitory computer-readable medium described herein, the non-contiguous subchannel combination for the second sidelink resource may be further based on a quantity of subchannels for the second sidelink resource and a quantity of subchannel indexes of the non-contiguous subchannel combination for the second sidelink resource.

In some examples of the method, UEs, and non-transitory computer-readable medium described herein, a quantity of bits of the index value of the frequency resource allocation may be based on a quantity of a set of multiple contiguous subchannel combinations for the multiple sidelink resources and a quantity of a set of multiple non-contiguous subchannel combinations for the multiple sidelink resources.

### BRIEF DESCRIPTION OF THE DRAWINGS

FIG. 1 shows an example of a wireless communications system that supports frequency resource allocation for non-contiguous subchannels in sidelink communications in accordance with one or more aspects of the present disclosure.

FIG. 2 shows an example of a wireless communications system that supports frequency resource allocation for non-contiguous subchannels in sidelink communications in accordance with one or more aspects of the present disclosure.

FIG. 3 shows an example of a process flow that supports frequency resource allocation for non-contiguous subchannels in sidelink communications in accordance with one or more aspects of the present disclosure.

FIGS. 4 and 5 show block diagrams of devices that support frequency resource allocation for non-contiguous subchannels in sidelink communications in accordance with one or more aspects of the present disclosure.

FIG. 6 shows a block diagram of a communications manager that supports frequency resource allocation for non-contiguous subchannels in sidelink communications in accordance with one or more aspects of the present disclosure.

FIG. 7 shows a diagram of a system including a device that supports frequency resource allocation for non-contiguous subchannels in sidelink communications in accordance with one or more aspects of the present disclosure.

FIGS. 8 through 11 show flowcharts illustrating methods that support frequency resource allocation for non-contiguous subchannels in sidelink communications in accordance with one or more aspects of the present disclosure.

### DETAILED DESCRIPTION

In some wireless communications systems, a network entity and a user equipment (UE) may communicate via frequencies that are a part of an unlicensed spectrum. In such cases, the network entity may indicate an uplink resource allocation for the unlicensed spectrum, where the uplink frequency resource allocation may include one or more interlaces. Such interlaces may be a combination of RBs within an RB set that are equally offset in frequency from each other. In some cases, the network entity may allocate non-contiguous interlace combinations (e.g., frequency resources not next to or sequential in the frequency domain). Such non-contiguous interlaces may enable the UE to transmit an uplink message with increased transmission power and without exceeding PSD limits.

In some cases, the UE may communicate with a second UE via frequencies of the unlicensed spectrum. In such cases, it may be beneficial for the UE to support non-contiguous interlaces (e.g., non-contiguous subchannels) to increase transmission power during the sidelink communications. However, unlike uplink communications, two or three resources may be allocated for the sidelink communications, such that the UE and the second UE may communicate an initial sidelink message via a first sidelink resource and communicate retransmissions of the initial sidelink message via the second and third sidelink resource. As such, using current resource allocation techniques, the UE may not be able to receive an indication of non-contiguous interlaces for the multiple sidelink resources, thereby being unable to increase transmission powers during the sidelink communications.

The techniques described herein may enable the UE to communicate with the second UE via non-contiguous subchannel combinations for interlace based resource allocation. For example, the UE may receive control signaling (e.g., sidelink control information (SCI) or radio resource control (RRC) signaling) that indicates a frequency resource allocation (e.g., a frequency resource indicator value (FRIV)) for at least a first sidelink resource and a second sidelink resource, where the frequency resource allocation indicates a non-contiguous subchannel combination (e.g., one or more RBs that are mapped to non-contiguous subchannels) for the second sidelink resource.

In response to receiving the control signaling, the UE may select (e.g., from a predefined table) a subchannel combination for the first sidelink resource based on a relationship between the first sidelink resource and the second sidelink resource and on a quantity of the multiple sidelink resources. In one example, the UE may determine that the subchannel combination for the first sidelink resource is to be the same as the non-contiguous subchannel combination for the second sidelink resource. In another example, the UE may select a second non-contiguous subchannel combination for the first sidelink resource based on a starting subchannel index of a physical sidelink control channel (PSCCH), a defined offset of the non-contiguous subchannel combination of the second resource, or a quantity of subchannels indicated via the frequency resource allocation. In some other examples, the UE may determine that the subchannel combination for the first sidelink resource is a contiguous subchannel combination.

Based on selecting the subchannel combination for the first sidelink resource, the UE may communicate with the second UE via a physical sidelink shared channel (PSSCH) using the multiple sidelink resources that have at least one non-contiguous subchannel combination. In this way, the UE may be able to communicate via the PSSCH using resources with non-contiguous subchannel combinations, thereby enabling the UE to increase transmission power of sidelink transmissions without exceeding PSD limits.

Aspects of the disclosure are initially described in the context of wireless communications systems. Aspects of the disclosure are further described in the context of a process flow. Aspects of the disclosure are further illustrated by and described with reference to apparatus diagrams, system diagrams, and flowcharts that relate to frequency resource allocation for non-contiguous subchannels in sidelink communications.

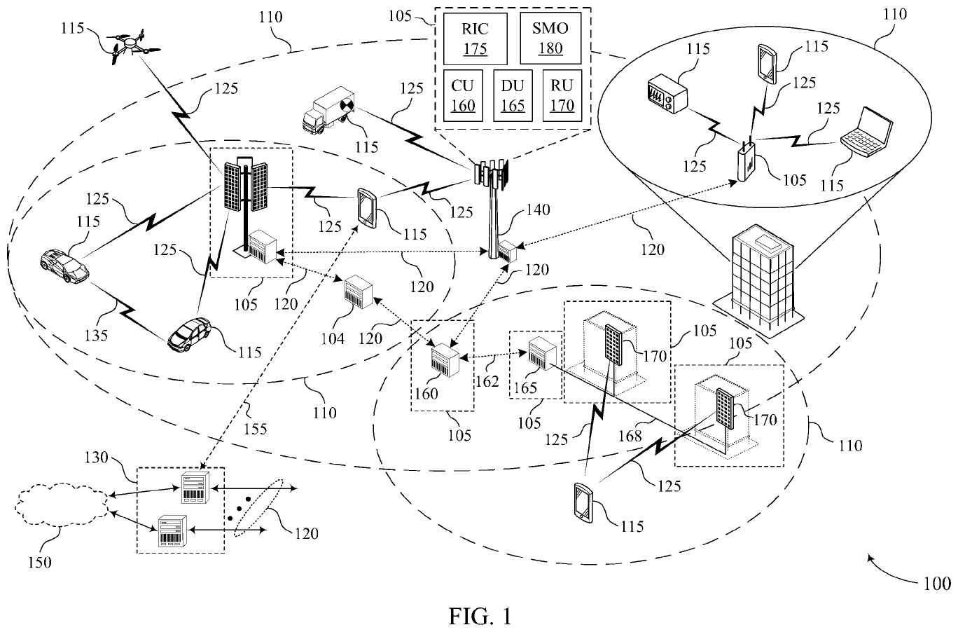

FIG. 1 shows an example of a wireless communications system 100 that supports frequency resource allocation for non-contiguous subchannels in sidelink communications in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support frequency resource allocation for non-contiguous subchannels in sidelink communications as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some cases, the network entity 105 and the UE 115 may communicate via frequencies that are a part of an unlicensed spectrum. In such cases, the network entity 105 may indicate an uplink resource allocation for the unlicensed spectrum, where the uplink frequency resource allocation may include one or more interlaces. Such interlaces may be a combination of RBs within an RB set that are equally offset in frequency from each other. In some cases, the network entity 105 may allocate non-contiguous interlace combinations. Such non-contiguous interlaces may enable the UE 115 to transmit an uplink message with increased transmission power and without exceeding PSD limits.

In some cases, the UE 115 may communicate with a second UE 115 via frequencies of the unlicensed spectrum. In such cases, it may be beneficial for the UE 115 to support non-contiguous interlaces (e.g., non-contiguous subchannels) to increase transmission power during the sidelink communications. However, unlike uplink communications, two or three resources may be allocated for the sidelink communications, such that the UE 115 and the second UE 115 may communicate an initial sidelink message via a first sidelink resource and communicate retransmissions of the initial sidelink message via the second and third sidelink resource. As such, using current resource allocation techniques, the UE 115 may not be able to receive an indication of non-contiguous subchannel combinations for the multiple sidelink resources, thereby being unable to increase transmission powers during the sidelink communications.

The techniques described herein may enable the UE 115 to communicate with the second UE 115 via non-contiguous subchannel combinations for interlace based resource allocation. For example, the UE 115 may receive control signaling that indicates a frequency resource allocation for at least a first sidelink resource and a second sidelink resource, where the frequency resource allocation indicates a non-contiguous subchannel combination (e.g., one or more RBs that are mapped to non-contiguous subchannels) for the second sidelink resource.

In response to receiving the control signaling, the UE 115 may select (e.g., from a predefined table) a subchannel combination for the first sidelink resource based on a relationship between the first sidelink resource and the second sidelink resource and on a quantity of the multiple sidelink resources. In one example, the UE 115 may determine that the subchannel combination for the first sidelink resource is to be the same as the non-contiguous subchannel combination for the second sidelink resource. In another example, the UE 115 may select a second non-contiguous subchannel combination for the first sidelink resource based on a starting subchannel index of a PSCCH, a defined offset of the non-contiguous subchannel combination of the second resource, or a quantity of subchannels indicated via the frequency resource allocation. In some other examples, the UE 115 may determine that the subchannel combination for the first sidelink resource is a contiguous subchannel combination. In this way, the UE 115 may be able to communicate via the PSSCH using resources with non-contiguous subchannel combinations, thereby enabling the UE 115 to increase transmission power of sidelink transmissions without exceeding PSD limits.

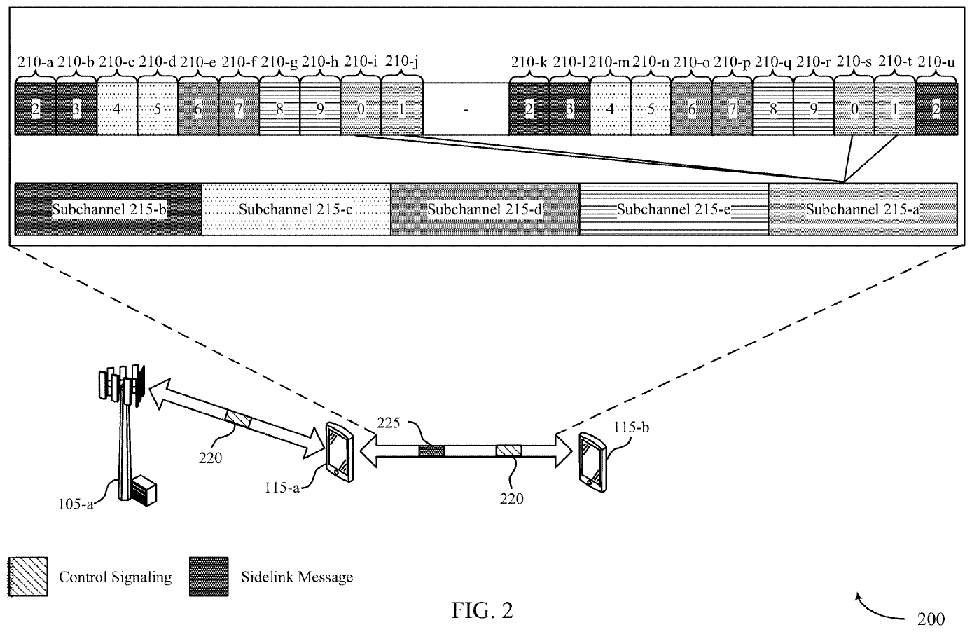

FIG. 2 shows an example of a wireless communications system 200 that supports frequency resource allocation for non-contiguous subchannels in sidelink communications in accordance with one or more aspects of the present disclosure. Aspects of the wireless communications system 200 may implement, or be implemented by, aspects of wireless communications system 100 as described herein with reference to FIG. 1. For example, the wireless communications system 200 may include a UE 115-a and a UE 115-b, which may be examples of the UEs 115 as described herein. Further, the wireless communications system 200 may include a network entity 105-a, which may be an example of the network entities 105 as described herein. The techniques described in the context of the wireless communications system 200 may enable the network entity 105-a, the UE 115-b, or both to indicate non-contiguous subchannel combinations for multiple sidelink resources in interlaced based sidelink communications.

In some cases, the UE 115-a may communicate with the network entity 105-a via a physical uplink shared channel (PUSCH) in an unlicensed spectrum (e.g., otherwise referred to as new radio-unlicensed (NR-U)). To facilitate such communications, the network entity 105-a may allocate an uplink resource for the UE 115-a to use to transmit the PUSCH. As such, for any 20 MHz bandwidth, the network entity 105-a may determine a frequency resource allocation, which may indicate which RBs 210 are allocated to the UE 115-a. To determine which RBs 210 may be used for the PUSCH, the network entity 105-a may determine an RB set 205 allocation and one or more interlace allocations from the RB set 205 for the uplink resource. Additionally, for NR-U communications, the UE 115-a may utilize interlaced PUSCH transmissions for various PUSCH types, which may include a message 3 (Msg3) PUSCH, a PUSCH scheduled by fallback and non-fallback downlink control information (DCI), Type 1 and Type 2 configured grant PUSCHs.

As described herein, the RB set 205 may refer to multiple RBs 210 that span multiple subchannels 215 of a 20 MHz bandwidth (e.g., the RB set 205 spans 20 MHz). In NR-U communications, the network entity 105-a may indicate which RBs 210 the UE 115-a is to use via one or more interlaces. For example, each RB set 205 may include, or otherwise be indexed by, one or more interlaces, where an interlace may be a combination of RBs 210 within the RB set 205 that are equally offset from each other. Further, each interlace may be mapped to a respective subchannel 215 of the 20 MHz bandwidth.

As an illustrative example, the RB set 205 may include 21 RBs 210 (e.g., an RB 210-a, an RB 210-b, an RB 210-c, an RB 210-d, an RB 210-e, an RB 210-f, an RB 210-g, an RB 210-h, an RB 210-i, an RB 210-j, an RB 210-k, an RB 210-1, an RB 210-m, an RB 210-n, an RB 210-o, an RB 210-p, an RB 210-q, an RB 210-r, an RB 210-s, an RB 210-t, and an RB 210-u) and the 21 RBs 210 may be split into 10 interlaces and span 5 subchannels 215 (e.g., a subchannel 215-a, a subchannel 215-b, a subchannel 215-c, a subchannel 215-d, and a subchannel 215-e). For example, the RB 210-i and the RB 210-s may be an interlace with an interlace index 0 and be mapped to the subchannel 215-a, while the RB 210-j and the RB 210-t may be a second interlace with an interlace index 1 and be mapped to the subchannel 215-a. In this way, the RB set 205 may be split into one or more interlaces that span the 20 MHz channel.

For interlaced PUSCH transmissions in a BWP, the network entity 105-a may indicate the interlace allocation for the PUSCH via a quantity of bits (e.g., X bits) of a control message, where the quantity of bits is based on the subcarrier spacing of the RB set 205. For example, for a 30 kHz subcarrier spacing, the network entity 105-a may use a 5-bit bitmap to indicate all possible interlace combinations. In such examples, for a 30 kHz subcarrier spacing, the RB set 205 may include 10 RBs 210 that are split into 5 interlaces. As such, the network entity 105-a may indicate, to the UE 115-a, a bitmap of “01001” indicating that the UE 115-a is to use the RBs 210 associated with the interlace with index 0 (e.g., the RB 210-i and the RB 210-s) and the RBs 210 associated with the interlace with index 3 (e.g., the RB 210-b and the RB 210-1). In this way, the network entity 105-a may indicate via a 5-bit bitmap interlace combinations that the UE 115-a is to use for the PUSCH transmission.

Alternatively, for a 15 kHz SCS, the network entity 105-a may indicate the interlace allocation via a 6-bit FRIV. For example, for 15 kHz subcarrier spacing, the RB set 205 may be split into 10 interlaces (as illustrated in FIG. 2). In order to indicate the interlace allocation, the network entity 105-a may transmit the FRIV (e.g., via 6 bits), where the FRIV may indicate the starting interlace index and a quantity of contiguous interlace indices from the start interlace index. As an illustrative example, if the UE 115-a receives the FRIV that indicates a starting interlace index of 2 and a quantity of contiguous interlace indices of 3, then the UE 115-a may use the RBs 210 that correspond to the interlaces with indices of 2 (e.g., the RB 210-a, the RB 210-k, and the RB 210-u), 3 (e.g., the RB 210-b and the RB 210-1), and 4 (e.g., the RB 210-c and the RB 210-m). In this way, the network entity 105-a may indicate contiguous interlace combinations for the resource allocation.

In some cases, the network entity 105-a may indicate one or more non-contiguous interlace combinations. To do so, the network entity 105-a may use remaining values (e.g., 9 remaining values) of the FRIV to indicate the pre-defined non-contiguous interlace combinations. For example, to indicate the start interlace index and quantity of consecutive interlace indices for all possible contiguous interlace combinations, the network entity 105-a may use FRIVs that range from 0 to 54. As such, to indicate the possible non-contiguous interlace combinations, the network entity 105-a may use the unused, or remaining, FRIVs that range from 55 to 63. The predefined non-contiguous interlace combinations may be indicated by each FRIV as detailed in Table 1:

TABLE 1

| RIV | Interlace Indices |
|---|---|
| 55 | 0, 5 |
| 56 | 0, 1, 5, 6 |
| 57 | 1, 6 |
| 58 | 1, 2, 3, 4, 6, 7, 8, 9 |
| 59 | 2, 7 |
| 60 | 2, 3, 4, 7, 8, 9 |
| 61 | 3, 8 |
| 62 | 4, 9 |
| 63 | Reserved |

By allocating non-contiguous interlace combinations, the network entity 105-a may also allocate various non-contiguous subchannel combinations for the PUSCH transmission, which may allow the UE 115-a to transmit the PUSCH with an increased transmit power without exceeding PSD limits. As an illustrative example, if the network entity 105-a indicates to the UE 115-a a FRIV of 55, then the UE 115-a may use the RBs 210 associated with the interlace index 0 (e.g., the RB 210-i and the RB 210-s) and the interlace index 5 (e.g., the RB 210-d and the RB 210-n), where the interlace 0 and the interlace 5 are non-contiguous in the frequency domain.

As described herein, a non-contiguous subchannel combination may refer to a resource that spans subchannels 215 that are not contiguous, or next to each other, in the frequency domain. As an illustrative example, the subchannel 215-c may be associated with the interlace 4 and the interlace 5, while the subchannel 215-a may be associated with the interlace 0 and the interlace 1. As such, because the combination of the interlace 4 and the interlace 5 and the combination of the interlace 0 and the interlace 1 are not next to each other in the frequency domain, the subchannel 215-c and the subchannel 215-a may be referred to as a non-contiguous subchannel combination.

In some cases, the UE 115-a may communicate with the UE 115-b via a PSSCH and support frequency domain resource indications for interlace RB-based PSSCH transmissions in the unlicensed spectrum (e.g., referred to as sidelink unlicensed (SL-U)). In such cases, the network entity 105-a (e.g., if operating in sidelink mode 1) or the UE 115-b (e.g., if operating in sidelink mode 2) may schedule multiple sidelink resources for transmission of the PSSCH. That is, the UE 115-a may receive a frequency resource allocation for up to three sidelink resources, where the first sidelink resource may be used for the initial transmission of the PSSCH and the remaining two sidelink resources may be used for retransmission of the PSSCH.

For example, the UE 115-a may receive an indication of one or more RB sets 205 to use for one or more PSSCH transmissions. The UE 115-b may indicate the one or more RB sets 205 via a FRIV information element (e.g., FRIV_{RBset}) of a first stage SCI. That is, the UE 115-b may calculate, or otherwise determine, which RB sets 205 to use based on a quantity of reserved resources for the PSSCH transmission. That is, if the UE 115-b is reserving two resources (e.g., sl-MaxNumPerReserve=2), then the UE 115-b may determine the RB set 205 using equation 1:

$${FRIV}_{RBset} = {n}_{RBset , 1}^{start} + {\sum }_{i = 1}^{{L}_{RBset} - 1} ( {N}_{RBset} + 1 - i ) \qquad ( 1 )$$

Otherwise, if the UE 115-b is reserving three resources for the PSSCH transmission, then the UE 115-b may determine the RB sets 205 using equation 2:

$${FRIV}_{RBset} = {n}_{RBset , 1}^{start} + ( {n}_{RBset , 2}^{start} * ( {n}_{RBset} + 1 - {L}_{RBset} ) ) + {\sum }_{i = 1}^{{L}_{RBset} - 1} {( {N}_{RBset} + 1 - i )}^{2} \qquad ( 2 )$$

In equations 1 and 2,

$${n}_{RBset , 1}^{start}$$

may denote the starting RB index for the second resource,

$${n}_{RBset , 2}^{start}$$

may denote the starting RB index for the third resource, N_{RBset} may denote the quantity of RB sets 205 in a sidelink resource pool, and L_{RBset} may denote the quantity of RB sets 205 for each indicated sidelink resource.

In addition to indicating the one or more RB sets 205 for each of the multiple sidelink resources, the UE 115-b may indicate the subchannels 215 for each of the multiple sidelink resources. The UE 115-b may indicate the subchannels 215 for the multiple sidelink resources via a subchannel FRIV information element (e.g., FRIV_{subCH}) of the first stage SCI. That is, the UE 115-b may calculate, or otherwise determine, which subchannels 215 to use based on a quantity of reserved resources for the PSSCH transmission. That is, if the UE 115-b is reserving two resources (e.g., sl-MaxNumPerReserve=2), then the UE 115-b may determine the subchannels 215 of the RB set 205 using equation 3:

$${FRIV}_{subCH} = {n}_{subCH , 1}^{start} + {\sum }_{i = 1}^{{L}_{subCH}^{RBset} - 1} ( {N}_{subchannel}^{RBset} + 1 - i ) \qquad ( 3 )$$

Otherwise, if the UE 115-b is reserving three resources for the PSSCH transmission, then the UE 115-b may determine subchannels 215 of the RB set 205 using equation 4:

$${FRIV}_{subCH} = {n}_{subCH , 1}^{start} + ( {n}_{subCH , 2}^{start} * ( {N}_{subchannel}^{RBset} + 1 - {L}_{subCH}^{RBset} ) ) + {\sum }_{i = 1}^{{L}_{subCH}^{RBset} - 1} {( {N}_{subchannel}^{RBset} + 1 - i )}^{2} \qquad ( 4 )$$

In equation 4,

$${n}_{subCH , 1}^{start}$$

may denote the starting subchannel 215 index for the second resource,

$${n}_{subCH , 2}^{start}$$

may denote the starting subchannel 215 index for the third resource,

$${N}_{subchannel}^{RBset}$$

may denote the quantity of subchannels 215 in each RB set 205 in a sidelink resource pool, and

$${L}_{subCH}^{RBset}$$

may denote the quality of used subchannels 215 for each RB set 205 of the indicated sidelink resource.

In such cases, however, the UE 115-b may not be able to indicate, via the subchannel FRIV information element (e.g., FRIV_{subCH}), non-contiguous interlaces (e.g., non-contiguous subchannel combinations). For example, as described herein, for

PUSCH transmissions in NR-U, the UE 115-a may support transmission via various non-contiguous interlace combinations (see Table 1), which may enable the UE 115-a to achieve a larger transmission power without exceeding PSD limits for the respective subchannels 215. In such cases, it may be beneficial for the UE to support non-contiguous interlaces (e.g., non-contiguous subchannels 215) for power boosting in PSSCH transmissions to the UE 115-b. However, unlike the PUSCH transmissions in NR-U, two or three resources may be allocated for the PSSCH transmission. As such, using current resource allocation techniques, the UE 115-a may not be able to receive a frequency resource allocation with one or more non-contiguous subchannel combinations for the multiple sidelink resources.

The techniques described herein may provide support for non-contiguous subchannel combinations for interlace-RB based resource allocation. For example, the UE 115-a may receive, from the network entity 105-a or the UE 115-b, control signaling 220 that indicates a FRIV (e.g., FRIV_{subCH} or frequency resource allocation) for multiple sidelink resources (e.g., up to three sidelink resources), where the FRIV may indicate a first sidelink resource for an initial transmission of a sidelink message 225, a second sidelink resource for a first retransmission of the sidelink message 225, a third sidelink resource for a second retransmission of the sidelink message 225, or a combination thereof.

In such examples, the FRIV may also indicate a non-contiguous subchannel combination for the second sidelink resource, a non-contiguous subchannel combination for the third sidelink resource, or both. Based on the control signaling, the UE 115-a may select (e.g., identify or determine) a subchannel combination for the first sidelink resource based on a relationship between the first sidelink resource and the second sidelink resource.

In some examples, the same non-contiguous subchannel combination may be used for each of the reserved resources. That is, the relationship between the first sidelink resource and the second sidelink resource may be that the subchannel combination for the first sidelink resources is equivalent to the non-contiguous subchannel combination for the second sidelink resource. Likewise, if three resources are reserved, the subchannel combination for the first sidelink resource, the subchannel combination for the second sidelink resource, and the subchannel combination for the third sidelink resource may be equivalent.

As such, in response to receiving the control signaling 220, the UE 115-a may select (e.g., identify, calculate, or determine) the non-contiguous subchannel combination to use for the second sidelink resource based on the FRIV (e.g., index value of the frequency resource allocation). That is, the UE 115-a may select the non-contiguous subchannel combination for the second sidelink resource based on a mapping between remaining FRIVs and various non-contiguous subchannel combinations. Based on selecting the non-contiguous subchannel combination for the second sidelink resource, the UE 115-a may apply the selected non-contiguous subchannel combination for each of the reserved sidelink resources.

In such examples, the non-contiguous subchannel combinations for the multiple sidelink resources may be predefined or preconfigured in one or more tables of a standard (e.g., such as the 3GPP standards). Each entry in the tables may be mapped to a remaining value of the FRIV, such that a first entry in the tables is mapped to a first remaining FRIV and a second entry in the tables is mapped to the second remaining FRIV. That is, the FRIV may be an index to the table and the remaining FRIVs may be indices to the non-contiguous subchannel combinations.

Each table may correspond to a quantity of subchannels 215 in the RB set 205. As such, if the RB set 205 includes 10 subchannels, then the UE 115-a may select the non-contiguous subchannel combination for the second sidelink resource from a table whose entries may correspond to interlace combinations as detailed in Table 1 (e.g., the set of non-contiguous subchannel combinations for NR-U can be reused by replacing the interlace indices with subchannel indices). Alternatively, if the RB set 205 includes five subchannels, then the UE 115-a may select the non-contiguous subchannel combination for the second sidelink resource from a table that includes a subset of subchannel combinations from all possible non-contiguous subchannel combinations.

In some examples, the UE 115-a may select the non-contiguous subchannel combination for the second sidelink resource from the table based on the FRIV and a relative subchannel combination with respect to a starting subchannel index of a PSCCH. Alternatively, the UE 115-a may select the non-contiguous subchannel combination for the second sidelink resource from the table based on the FRIV, where the entries in the table correspond to an absolute mapping between the FRIV and the subchannel combinations.

Table 2 may be an example of a mapping between the remaining FRIV values and non-contiguous subchannel combinations for an RB set 205 that includes 10 subchannels 215.

TABLE 2
Mapping between remaining FRIVs and subchannel
combinations for 10 subchannels in the RB set.

| | Remaining FRIV | | |
|---|---|---|---|
| | Sl-MaxNumPerRe- | Sl-MaxNumPerRe- | Subchannel |
| Entry | serve = 2 | serve = 3 | Combinations |
| 0 | 55 | 385 | 0, 5 |
| 1 | 56 | 386 | 0, 1, 5, 6 |
| 2 | 57 | 387 | 0, 1, 2, |
| | | | 5, 6, 7 |
| 3 | 58 | 388 | 0, 1, 2, 3, |
| | | | 5, 6, 7, 8 |
| . . . | . . . | . . . | Reserved |

As described herein, in one example, the UE 115-a may select the non-contiguous subchannel combination for the multiple reserved resources based on the FRIV indicated via the control signaling 220 and on a relative subchannel combination with respect to a starting subchannel index of a PSCCH.

As an illustrative example, the UE 115-a may receive the control signaling 220 that indicates an FRIV for multiple sidelink resources, where the FRIV is equal to 55. Further, the UE 115-a may also blindly detect a PSCCH in a subchannel 215 that has a starting subchannel index of 1. As such, the UE 115-a may select the non-contiguous subchannel combination for the multiple sidelink resources based on the FRIV of 55 and the starting PSCCH subchannel index of 1. For example, the UE 115-a may identify that the FRIV value of 55 corresponds to the non-contiguous subchannel combination of {0, 5} and add the starting subchannel index of the PSCCH to the indices of the non-contiguous subchannel combination of {0,5}, such that the entries in Table 2 are relative to the starting subchannel index of the PSCCH. That is, the UE 115-a may add the starting subchannel index of the PSCCH to each subchannel combination in Table 2, such that the subchannel combinations of Table 2 are relative to the starting subchannel index of the PSCCH.

In such examples, the UE 115-a may select, the non-contiguous subchannel combination of {1,6} for the multiple reserved resources (e.g., {0,5}+1={1,6}). In this way, the UE 115-a may determine that the non-contiguous subchannel combination for the multiple sidelink resources is {1,6}.

Table 3 may be another example of a mapping between the remaining FRIV values for each quantity of reserved sidelink resources and non-contiguous subchannel combinations for an RB set 205 that includes 10 subchannels 215.

TABLE 3
Mapping between remaining FRIVs and subchannel
combinations for 10 subchannels in the RB set.

| | Remaining FRIV | | |
|---|---|---|---|
| | Sl-MaxNumPerRe- | Sl-MaxNumPerRe- | Subchannel |
| Entry | serve = 2 | serve = 3 | Combinations |
| 0 | 55 | 385 | 0, 5 |
| 1 | 56 | 386 | 0, 1, 5, 6 |
| 2 | 57 | 387 | 1, 6 |
| 3 | 58 | 388 | 1, 2, 3, 4, |
| | | | 6, 7, 8, 9 |
| 4 | 59 | 389 | 2, 7 |
| 5 | 60 | 390 | 2, 3, 4, |
| | | | 7, 8, 9 |
| 6 | 61 | 391 | 3, 8 |
| 7 | 62 | 392 | 4, 9 |
| . . . | . . . | . . . | Reserved |

As described herein, in one example, the UE 115-a may select the non-contiguous subchannel combination for the multiple reserved resources based on an absolute mapping between the FRIV indicated via the control signaling 220 and the non-contiguous subchannel combinations.

As an illustrative example, the UE 115-a may receive the control signaling 220 that indicates an FRIV for multiple sidelink resources, where the FRIV is equal to 55. As such, the UE 115-a may select the non-contiguous subchannel combination for the multiple sidelink resources that corresponds to the FRIV of 55. For example, the UE 115-a may identify that the FRIV value of 55 corresponds to the non-contiguous subchannel combination of {0, 5} as detailed in table 3. In this way, the UE 115-a may determine that the non-contiguous subchannel combination for the multiple sidelink resources is {0,5} based on an absolute mapping between the FRIV and the non-contiguous subchannel combinations.

In some examples, the RB set 205 may include 5 subchannels 215. In such examples, the UE 115-a may select the non-contiguous subchannel combination for the second sidelink resource from a table that includes a subset of subchannel combinations from all possible non-contiguous subchannel combinations.

Table 4 may show a portion of all possible non-contiguous subchannel combinations for an RB set 205 with 5 subchannels.

TABLE 4
All Possible Subchannel Combinations
for five subchannels in the RB set.

| Rows | Subchannel Combinations |
|---|---|
| 0 | 0, 2 |
| 1 | 0, 3 |
| 2 | 0, 4 |
| 3 | 1, 3 |
| 4 | 1, 4 |
| 5 | 2, 4 |
| 6 | 0, 1, 3 |
| 7 | 0, 1, 4 |
| 8 | 0, 2, 3 |
| 9 | 0, 2, 4 |
| 10 | 0, 3, 4 |
| 11 | 1, 2, 4 |
| 12 | 1, 3, 4 |
| 13 | 0, 1, 2, 4 |
| 14 | 0, 1, 3, 4 |
| 15 | 0, 2, 3, 4 |
| . . . | . . . |

As such, the UE 115-a may select, from a subset of all possible non-contiguous subchannel combinations, the non-contiguous subchannel combination for the multiple sidelink reserved resources as detailed in Table 5.

TABLE 5
Mapping between remaining FRIV and configured subchannel
combinations for five subchannels in the RB set.

| | Remaining FRIV | | |
|---|---|---|---|
| | Sl-MaxNumPerRe- | Sl-MaxNumPerRe- | Subchannel |
| Entry | serve = 2 | serve = 3 | Combinations |
| 0 | 15 | 55 | 1^{st} non- |
| | | | contiguous |
| | | | subchannel |
| | | | combination |
| 1 | 16 | 56 | 2^{nd} non- |
| | | | contiguous |
| | | | subchannel |
| | | | combination |
| 2 | 17 | 57 | . . . |
| 3 | 18 | 58 | . . . |
| 4 | 19 | 59 | . . . |
| 5 | 20 | 60 | N^{th} non- |
| | | | contiguous |
| | | | subchannel |
| | | | combination |
| . . . | . . . | . . . | Reserved |

In such examples, the UE 115-a may select the non-contiguous subchannel combination for the multiple reserved resources based on the FRIV indicated via the control signaling 220 and on a relative subchannel combination with respect to a starting subchannel index of a PSCCH.

As an illustrative example, the UE 115-a may receive the control signaling 220 that indicates an FRIV for multiple sidelink resources, where the FRIV is equal to 16. Further, the UE 115-a may also blindly detect a PSCCH in a subchannel 215. As such, the UE 115-a may identify that the FRIV value of 16 corresponds to the 2^{nd} non-contiguous subchannel combination. Based on identifying the 2^{nd} non-contiguous subchannel combination, the UE 115-a may add the starting subchannel index of the PSCCH to the indices of the 2^{nd} non-contiguous subchannel combination in order to identify the subchannel combination for the multiple sidelink resources. That is, the UE 115-a may add the starting subchannel index of the PSCCH to each subchannel combination in Table 5, such that the subchannel combinations of Table 5 are relative to the starting subchannel index of the PSCCH.

In this way, the UE 115-a may determine that the non-contiguous subchannel combination for the multiple sidelink resources based on the FRIV and the starting subchannel index of the PSCCH.

Alternatively, the UE 115-a may select the non-contiguous subchannel combination for the multiple reserved resources based on an absolute mapping between the FRIV indicated via the control signaling 220 and the non-contiguous subchannel combinations. As an illustrative example, the UE 115-a may receive the control signaling 220 that indicates an FRIV for multiple sidelink resources, where the FRIV is equal to 16. As such, the UE 115-a may select the non-contiguous subchannel combination for the multiple sidelink resources that corresponds to the FRIV of 16. For example, the UE 115-a may identify that the FRIV value of 16 corresponds to the 2^{nd} non-contiguous subchannel combination as shown in table 5. In this way, the UE 115-a may determine the non-contiguous subchannel combination for the multiple sidelink resources based on an absolute mapping between the FRIV and the non-contiguous subchannel combinations.

In such examples, the network entity 105-a, the UE 115-b, or both may determine a quantity of bits of the FRIV based on a quantity of contiguous subchannel combinations

$$( {N}_{subCH}^{contigous} )$$

and a quantity or non-contiguous subchannel combinations

$$( e . g . , {N}_{subCH}^{non - contigous} )$$

that may be allocated for the multiple sidelink resources using equation 5:

$$⌈ {log}_{2} ( {N}_{subCH}^{contigous} + {N}_{subCH}^{non - contigous} ) ⌉ \qquad ( 5 )$$

In this way, because each resource has the same non-contiguous subchannel combination, the UE 115-a may receive the FRIV for a single non-contiguous subchannel combination, select the non-contiguous subchannel combination based on the FRIV, and apply the non-contiguous subchannel combination to each reserved sidelink resource, thereby enabling the UE 115-a to support non-contiguous subchannel combinations for multiple sidelink resources in interlaced RB based PSSCH transmissions.

In some other examples, each of the reserved sidelink resources may have different non-contiguous subchannel combinations, where each non-contiguous subchannel combination for the multiple sidelink resources have the same quantity of subchannels. That is, the relationship between the first sidelink resource and the second sidelink resource may be that the subchannel combination for the first sidelink resource is non-contiguous, is different from the non-contiguous subchannel combination of the second sidelink resource, and includes the same quantity of subchannels as the non-contiguous subchannel combination for the second sidelink resource.

In one example, if a non-contiguous subchannel combination is indicated for one of the multiple sidelink resources, then subchannel combinations for each of the multiple sidelink resources may be non-contiguous. For example, a set of non-contiguous subchannel combinations may be predefined or preconfigured for the second sidelink resource, the third sidelink resource, or both in a table, where each entry in the table corresponds to a subchannel combination associated with the second sidelink resource, the third sidelink resource, or both (e.g., the table has entries for one or more future reserved resources). Each entry in the table may be mapped to a remaining value of the FRIV, such that a first entry in the table is mapped to a first remaining FRIV and a second entry in the table is mapped to the second remaining FRIV. That is, the FRIV may be an index to the table and the remaining FRIVs may be indices to the non-contiguous subchannel combinations.

Additionally, each table may correspond to a quantity of subchannels 215 in the RB set 205. As such, if the RB set 205 includes 10 subchannels, then the UE 115-a may select the non-contiguous subchannel combination for the second sidelink resource from a table whose entries may correspond to interlace combinations as detailed in Table 1 (e.g., the set of non-contiguous subchannel combinations for NR-U can be reused by replacing the interlace indices with subchannel indices). Alternatively, if the RB set 205 includes five subchannels, then the UE 115-a may select the non-contiguous subchannel combination for the second sidelink resource from a table that includes a subset of subchannel combinations from all possible non-contiguous subchannel combinations.

In response to receiving the control signaling 220, the UE 115-a may select the non-contiguous subchannel combination for the second sidelink resource from the table based on a relative subchannel combination with respect to a starting subchannel index of a PSCCH. Alternatively, the UE 115-a may select the non-contiguous subchannel combination for the second sidelink resource from the table based on the FRIV, where the entries in the table correspond to an absolute mapping between the FRIV and the subchannel combinations.

For example, in response to receiving the control signaling 220 indicating the FRIV, the UE 115-a may select the non-contiguous subchannel combination for the second resource based on the mapping between the FRIV and the non-contiguous subchannel combinations from the table, the starting subchannel index of a PSCCH, or both. Further, if the quantity of reserved resources is 3 (e.g., Sl-MaxNumPerReserve=3), then the UE 115-a may determine the non-contiguous subchannel combination for the second sidelink resource and a non-contiguous subchannel combination for the third sidelink resource based at least on the mapping between the FRIV and the non-contiguous subchannel combinations from the table, the starting subchannel index of a PSCCH, or both.

Upon selecting the non-contiguous subchannel combination for the second resource, selecting the non-contiguous subchannel combination for the third resource, or both, the UE 115-a may select a non-contiguous subchannel combination for the first sidelink resource.

In one example, for the first sidelink resource, if relative subchannel combinations are defined or preconfigured in the table, then the UE 115-a may determine the non-contiguous subchannel combination for the first sidelink resource implicitly based on a starting subchannel index of a PSCCH and a defined offset. In such examples, the UE 115-a may calculate the defined offset based on a difference between the indices of the non-contiguous subchannel combination indicated for the second sidelink resource, the indices of the non-contiguous subchannel combination indicated for the third sidelink resource, or both. Alternatively, the UE 115-a may receive, via bit field in the control signaling 220, an indication of the defined offset.

In another example, for the first sidelink resource, if absolute subchannel combinations are defined or preconfigured in the table, the UE 115-a may select the subchannel combination for the first sidelink resource based on the starting subchannel index of the PSCCH and a quantity of subchannels indicated by the FRIV. For example, the UE 115-a may select, from among the subchannel combinations configured for the second and third sidelink resources (e.g., from the entries of the predefined or configured table), a non-contiguous subchannel combination for the first sidelink resource that has the same starting subchannel index as the PSCCH and has a same quantity of subchannels as indicated by the FRIV.

In such examples, if there are multiple non-contiguous subchannel combinations associated with the same starting subchannel index of the PSCCH and having a same quantity of subchannel combinations indicated by FRIV value, then the UE 115-a may select a non-contiguous subchannel combination that corresponds to a threshold FRIV.

In one example, if there are multiple non-contiguous subchannel combinations associated with the same starting subchannel index of PSCCH and having same quantity of subchannel combinations indicated by FRIV value, then the first or last non-contiguous subchannel combination is used for the first sidelink resource. In such examples, the first non-contiguous subchannel combination may correspond to the non-contiguous subchannel combination mapped to the lowest remaining FRIV among the multiple non-contiguous subchannel combinations and the last non-contiguous subchannel combination may correspond to the non-contiguous subchannel combination mapped to highest remaining RIV value among the multiple non-contiguous subchannel combinations.

Alternatively, if there are multiple non-contiguous subchannel combinations associated with the same starting subchannel index of PSCCH and having same quantity of subchannel combinations indicated by FRIV value, then the UE 115-a may receive, via a bit field in SCI, an indication of which non-contiguous subchannel combination from the multiple subchannel combinations is to be allocated for the first sidelink resource.

Table 6 may be an example of a mapping between the remaining FRIV values and non-contiguous subchannel combinations for an RB set 205 that includes 10 subchannels 215 and when two sidelink resources are reserved (e.g., sl-MaxNumPerReserve=2).

TABLE 6
Mapping between remaining FRIVs and subchannel
combinations for 10 subchannels in the RB set
and quantity of reserved sidelink resources is 2.

| | | Subchannel |
|---|---|---|
| | Remaining | Combinations for |
| Row | FRIV | Second Resource |
| 0 | 55 | 0, 5 |
| 1 | 56 | 0, 1, 5, 6 |
| 2 | 57 | 1, 6 |
| 3 | 58 | 1, 2, 3, 4, 6, 7, 8, 9 |
| 4 | 59 | 2, 7 |
| 5 | 60 | 2, 3, 4, 7, 8, 9 |
| 6 | 61 | 3, 8 |
| 7 | 62 | 4, 9 |
| . . . | . . . | Reserved |

As described herein, in one example, if relative subchannel combinations are defined or preconfigured in the table, then the UE 115-a may determine the non-contiguous subchannel combination for the second sidelink resource based on the FRIV and a starting subchannel index of a PSCCH. Further, the UE 115-a may select the non-contiguous subchannel combination for the first sidelink resource based on the starting subchannel index of the PSCCH and a defined offset between the indices of the non-contiguous subchannel for the second sidelink resource.

As an illustrative example, the UE 115-a may receive the control signaling 220 that indicates an FRIV for multiple sidelink resources, where the FRIV is equal to 59. Further, the UE 115-a may also blindly detect a PSCCH in a subchannel 215, where the starting subchannel index of the PSCCH may be equal to 1. As such, the UE 115-a may identify that the FRIV value of 59 is mapped to the non-contiguous subchannel combination of {2,7} as detailed in Table 6 and add each subchannel index of the non-contiguous subchannel combination {2,7} with the starting subchannel index of the PSCCH of 1, such that the entries in Table 6 are relative to the starting subchannel index of the PSCCH. In such examples, the UE 115-a may identify that the non-contiguous subchannel combination for the second sidelink resource is {3,8} (e.g., {2,7}+1={3, 8}).

In response to identifying the non-contiguous subchannel for the second sidelink resource (e.g., {3,8}), the UE 115-a may select the non-contiguous subchannel combination for the first sidelink resource based on a quantity of subchannels of the non-contiguous subchannel combination for the second sidelink resource (e.g., 2 subchannels), the starting subchannel index of a PSCCH (e.g., subchannel index 1), and the defined offset between the indices of the non-contiguous subchannel for the second sidelink resource (e.g., an offset between 8 and 3).

For example, the UE 115-a may subtract the indices of the non-contiguous subchannel combination for the second sidelink resource to calculate the defined offset of 5. Alternatively, the UE 115-a may receive, via the control signaling 220, that the defined offset is to be 5.

In response to identifying the defined offset, the UE 115-a may select the non-contiguous subchannel combination of {1,6} for the first sidelink resource, such that the non-contiguous subchannel combination for the first sidelink resource includes two subchannels 215 (e.g., subchannels 215 with indices 1 and 6, respectively) whose indices are separated by an offset of 5 (e.g., 6−1=5) and includes the same starting subchannel index as the starting subchannel index of the PSCCH (e.g., subchannel 215 with an index 1). In this way, the UE 115-a may select different non-contiguous sidelink combinations for two sidelink resources.

Alternatively, if absolute subchannel combinations are defined or preconfigured in the table, the UE 115-a may select the non-contiguous subchannel combination for the second sidelink resource based on the FRIV. Based on selecting the non-contiguous subchannel combination for the second sidelink resource, the UE 115-a may select the non-contiguous subchannel combination for the first sidelink resource based on the starting subchannel index of the PSCCH and a quantity of subchannels indicated by the FRIV.

As an illustrative example, the UE 115-a may receive the control signaling 220 that indicates an FRIV for multiple sidelink resources, where the FRIV is equal to 59. Further, the UE 115-a may also blindly detect a PSCCH in a subchannel 215, where the starting subchannel index of the PSCCH may be equal to 1. As such, the UE 115-a may identify that the FRIV value of 59 is mapped to the non-contiguous subchannel combination of {2,7} as detailed in Table 6. Thus, the UE 115-a may select the non-contiguous subchannel combination of {2,7} for the second sidelink resource.

The UE 115-a may select the non-contiguous subchannel combination of {1,6} for the first sidelink resource, such that the non-contiguous subchannel combination for the first sidelink resource has the same starting subchannel index as the PSCCH (e.g., a subchannel with the index 1) and includes 2 subchannels (e.g., subchannels with indices 1 and 6). In this way, the UE 115-a may determine the non-contiguous subchannel combination for the second sidelink resources based on an absolute mapping between the FRIV and the non-contiguous subchannel combinations and determine the non-contiguous subchannel combination for the first sidelink resource based on the starting subchannel index of the PSCCH and the quantity of subchannels in the non-contiguous subchannel combination for the second sidelink resource.

Table 7 may be an example of a mapping between the remaining FRIV values and non-contiguous subchannel combinations for an RB set 205 that includes 10 subchannels 215 and when three sidelink resources are reserved (e.g., sl-MaxNumPerReserve=3). In the example of Table 7, each row may correspond to a RRC configured subchannel combinations for the second sidelink resource and the third sidelink resource.

TABLE 7
Mapping between remaining FRIVs and subchannel
combinations for 10 subchannels in the RB set
and quantity of reserved sidelink resources is 3.

| | | Subchannel | Subchannel |
|---|---|---|---|
| | Remaining | Combinations for | Combinations for |
| Row | FRIV | Second Resource | Third Resource |
| 0 | 385 | 0, 5 | 0, 5 |
| 1 | 386 | 0, 5 | 1, 6 |
| 2 | 387 | 0, 5 | 2, 7 |
| 3 | 388 | 0, 5 | 3, 8 |
| 4 | 389 | 0, 5 | 4, 9 |
| 5 | 390 | 0, 1, 5, 6 | 0, 1, 5, 6 |
| 6 | 391 | 1, 6 | 0, 5 |
| 7 | 392 | 1, 6 | 1, 6 |
| 8 | 393 | 1, 6 | 2, 7 |
| 9 | 394 | 1, 6 | 3, 8 |
| 10 | 395 | 1, 6 | 4, 9 |
| 11 | 396 | 1, 2, 3, 4, 6, 7, 8, 9 | 1, 2, 3, 4, 6, 7, 8, 9 |
| 12 | 397 | 2, 7 | 0, 5 |
| 13 | 398 | 2, 7 | 1, 6 |
| 14 | 399 | 2, 7 | 2, 7 |
| 15 | 400 | 2, 7 | 3, 8 |
| 16 | 401 | 2, 7 | 4, 9 |
| 17 | 402 | 2, 3, 4, 7, 8, 9 | 2, 3, 4, 7, 8, 9 |
| 18 | 403 | 3, 8 | 0, 5 |
| 19 | 404 | 3, 8 | 1, 6 |
| 20 | 405 | 3, 8 | 2, 7 |
| 21 | 406 | 3, 8 | 3, 8 |
| 22 | 407 | 3, 8 | 4, 9 |
| 23 | 408 | 4, 9 | 0, 5 |
| 24 | 409 | 4, 9 | 1, 6 |
| 25 | 410 | 4, 9 | 2, 7 |
| 26 | 411 | 4, 9 | 3, 8 |
| 27 | 412 | 4, 9 | 4, 9 |
| . . . | . . . | Reserved | Reserved |

In one example, if relative subchannel combinations are defined or preconfigured in the table 7, then the UE 115-a may determine the non-contiguous subchannel combination for the third sidelink resource based on the absolute mapping between the FRIV and the non-contiguous subchannel combinations as detailed in Table 7. In such examples, the UE 115-a may determine the non-contiguous subchannel combination for the second sidelink resource based on a starting subchannel index of a PSCCH and the non-contiguous subchannel combination for the second sidelink resource. Further, the UE 115-a may select the non-contiguous subchannel combination for the first sidelink resource based on the starting subchannel index of the PSCCH and a defined offset between the indices of the non-contiguous subchannel for the second sidelink resource or the third sidelink resource.

As an illustrative example, the UE 115-a may receive the control signaling 220 that indicates an FRIV for multiple sidelink resources, where the FRIV is equal to 338. Further, the UE 115-a may also blindly detect a PSCCH in a subchannel 215, where the starting subchannel index of the PSCCH may be equal to 1. As such, the UE 115-a may identify that the FRIV value of 338 is mapped to the non-contiguous subchannel combination of {3,8} for the third sidelink resource as detailed in Table 7 and select the non-contiguous subchannel combination of {3,8} for the third sidelink resource.

The UE 115-a may further add each subchannel index of the non-contiguous subchannel combination {3,8} with the starting subchannel index of the PSCCH of 1, in order to identify the non-contiguous subchannel combination for the second sidelink resource. That is, the UE 115-a may add the starting subchannel index of the PSCCH to each entry in the Table 7, such that the non-contiguous subchannel combinations of Table 7 are relative to the starting subchannel index of the PSCCH. In such examples, the UE 115-a may identify that the non-contiguous subchannel combination for the second sidelink resource is {4,9} (e.g., {3,8}+1={4,9}).

In response to identifying the non-contiguous subchannel combination for the second sidelink resource (e.g., {4,9}) and the non-contiguous subchannel combination for the third sidelink resource (e.g., {3,8}, the UE 115-a may select the non-contiguous subchannel combination for the first sidelink resource based on a quantity of subchannels of the non-contiguous subchannel combination for the second sidelink resource (e.g., 2 subchannels), the starting subchannel index of a PSCCH (e.g., subchannel index 1), and the defined offset between the indices of the non-contiguous subchannel for the second sidelink resource (e.g., an offset between 9 and 4).

For example, the UE 115-a may subtract the indices of the non-contiguous subchannel combination for the second sidelink resource to calculate the defined offset of 5. Alternatively, the UE 115-a may receive, via the control signaling 220, that the defined offset is to be 5.

In response to identifying the defined offset, the UE 115-a may select the non-contiguous subchannel combination of {1,6} for the first sidelink resource, such that the non-contiguous subchannel combination for the first sidelink resource includes two subchannels 215 (e.g., subchannels 215 with indices 1 and 6, respectively) whose indices are separated by an offset of 5 (e.g., 6−1=5) and includes the same starting subchannel index as the starting subchannel index of the PSCCH (e.g., subchannel 215 with an index 1). In this way, the UE 115-a may select different non-contiguous sidelink combinations for three sidelink resources.

Alternatively, if absolute subchannel combinations are defined or preconfigured in the table, the UE 115-a may select the non-contiguous subchannel combination for the second sidelink resource and select the non-contiguous subchannel combination for the third sidelink resource based on the absolute mapping between FRIV and the non-contiguous subchannel combinations as detailed in Table 7. Based on selecting the non-contiguous subchannel combinations for the second sidelink resource and the third sidelink resource, the UE 115-a may select the non-contiguous subchannel combination for the first sidelink resource based on the starting subchannel index of the PSCCH and a quantity of subchannels indicated by the FRIV.

As an illustrative example, the UE 115-a may receive the control signaling 220 that indicates an FRIV for multiple sidelink resources, where the FRIV is equal to 338. Further, the UE 115-a may also blindly detect a PSCCH in a subchannel 215, where the starting subchannel index of the PSCCH may be equal to 1. As such, the UE 115-a may identify that the FRIV value of 338 is mapped to the non-contiguous subchannel combination of {3,8} for the third sidelink resource as detailed in Table 7 and select the non-contiguous subchannel combination of {3,8} for the third sidelink resource. Additionally, the UE 115-a may identify that the FRIV value of 338 is mapped to the non-contiguous combination of {0,5} for the second sidelink resource as detailed in Table 7 and select the non-contiguous subchannel combination of {0,5} for the second sidelink resource.

As such, because the non-contiguous subchannel combination for the first sidelink resource is based on the non-contiguous subchannel combination for the second sidelink resource, the UE 115-a may select the non-contiguous subchannel combination of {1,6} for the first sidelink resource, such that the non-contiguous subchannel combination for the first sidelink resource has the same starting subchannel index as the PSCCH (e.g., a subchannel with the index 1) and includes 2 subchannels (e.g., subchannels with indices 1 and 6). In this way, the UE 115-a may determine the non-contiguous subchannel combination for the second sidelink resource and the third sidelink resource based on an absolute mapping between the FRIV and the non-contiguous subchannel combinations and determine the non-contiguous subchannel combination for the first sidelink resource based on the starting subchannel index of the PSCCH and the quantity of subchannels in the non-contiguous subchannel combination for the second sidelink resource.

Table 8 may be an example of a mapping between the remaining FRIV values and non-contiguous subchannel combinations for an RB set 205 that includes 5 subchannels 215 and when two sidelink resources are reserved (e.g., sl-MaxNumPerReserve=2).

TABLE 8
Mapping between remaining FRIVs and subchannel
combinations for 5 subchannels in the RB set and
quantity of reserved sidelink resources is 2.

| | | Subchannel |
|---|---|---|
| | Remaining | Combinations for |
| Rows | FRIV | Second Resource |
| 0 | 15 | 1^{st} non-contiguous |
| | | subchannel combination |
| 1 | 16 | 2^{nd} non-contiguous |
| | | subchannel combination |
| 2 | 17 | 3^{rd} non-contiguous |
| | | subchannel combination |
| 3 | 18 | 4^{th} non-contiguous |
| | | subchannel combination |
| . . . | . . . | |

In such examples, the UE 115-a may select the non-contiguous subchannel combination for the second sidelink resource based on the FRIV indicated via the control signaling 220 and on a relative subchannel combination with respect to a starting subchannel index of a PSCCH. Further, the UE 115-a may select the non-contiguous subchannel combination for the first sidelink resource based on the starting subchannel index of the PSCCH and the defined offset between the indices of the non-contiguous subchannel combination for the second sidelink resource.

As an illustrative example, the UE 115-a may receive the control signaling 220 that indicates an FRIV for the second sidelink resource, where the FRIV is equal to 16. Further, the UE 115-a may also blindly detect a PSCCH in a subchannel 215. As such, the UE 115-a may identify that the FRIV value of 16 corresponds to the 2^{nd} non-contiguous subchannel combination and add each index of the 2^{nd} non-contiguous subchannel combination with the starting PSCCH subchannel index to obtain the non-contiguous subchannel combination for the second sidelink resource. That is, the UE 115-a may add the starting subchannel index of the PSCCH to each subchannel combination in Table 8, such that the subchannel combinations of Table 8 are relative to the starting subchannel index of the PSCCH.

In response to obtaining the non-contiguous subchannel combination for the second sidelink resource, the UE 115-a may subtract the indices of the non-contiguous subchannel combination for the second sidelink resource to calculate the defined offset. Alternatively, the UE 115-a may receive, via the control signaling 220, that the defined offset.

Based on identifying the defined offset (e.g., either calculate or receive), the UE 115-a may select the non-contiguous subchannel combination for the first sidelink resource, such that the non-contiguous subchannel combination for the first sidelink resource has the same starting subchannel index as the starting index for the PSCCH and includes the same quantity of subchannels as the non-contiguous subchannel combination for the second sidelink resource. In this way, the UE 115-a may determine that the non-contiguous subchannel combination for the second sidelink resource based on the FRIV and the starting subchannel index of the PSCCH and determine the non-contiguous subchannel combination for the first sidelink resource based on the starting subchannel index of the PSCCH and the defined offset.

Alternatively, the UE 115-a may select the non-contiguous subchannel combination for the second sidelink resource based on an absolute mapping between the FRIV indicated via the control signaling 220 and the non-contiguous subchannel combinations. Based on selecting the non-contiguous subchannel combination for the second sidelink resource, the UE 115-a may select the non-contiguous subchannel combination for the first sidelink resource based on the starting subchannel index of the PSCCH and a quantity of subchannels indicated by the FRIV.

As an illustrative example, the UE 115-a may receive the control signaling 220 that indicates an FRIV for the second sidelink resource, where the FRIV is equal to 16. As such, the UE 115-a may select the non-contiguous subchannel combination for the second sidelink that corresponds to the FRIV of 16. For example, the UE 115-a may identify that the FRIV value of 16 corresponds to the 2^{nd} non-contiguous subchannel combination as shown in table 8. Based on selecting the 2^{nd} non-contiguous subchannel combination for the second sidelink resource, the UE 115-a may select, from Table 5, a non-contiguous subchannel combination for the first sidelink resource that includes the same quantity of subchannels indicated by the FRIV and has the same starting subchannel index as the starting subchannel index of the PSCCH.

Table 9 may be an example of a mapping between the remaining FRIV values and non-contiguous subchannel combinations for an RB set 205 that includes 5 subchannels 215 and when three sidelink resources are reserved (e.g., sl-MaxNumPerReserve=3).

TABLE 9
Mapping between remaining FRIVs and subchannel
combinations for 5 subchannels in the RB set and
quantity of reserved sidelink resources is 3.

| | | | |
|---|---|---|---|
| | | Subchannel | Subchannel |
| | Remaining | Combinations for | Combinations for |
| Rows | RIV | Second Resource | Third Resource |

| | | |
|---|---|---|
| 0 | 55 | 1^{st} configured non-contiguous |
| | | subchannel combination list |
| 1 | 56 | 2^{nd} configured non-contiguous |
| | | subchannel combination list |
| 2 | 57 | . . . |
| 3 | 58 | . . . |
| 4 | 59 | N^{th} configured non-contiguous |
| | | subchannel combination list |
| . . . | . . . | . . . |

In one example, if relative subchannel combinations are defined or preconfigured in the table 9, then the UE 115-a may determine the non-contiguous subchannel combination for the third sidelink resource based on the absolute mapping between the FRIV and the non-contiguous subchannel combinations as detailed in Table 9. In such examples, the UE 115-a may determine the non-contiguous subchannel combination for the second sidelink resource based on a starting subchannel index of a PSCCH and the non-contiguous subchannel combination for the second sidelink resource. Further, the UE 115-a may select the non-contiguous subchannel combination for the first sidelink resource based on the starting subchannel index of the PSCCH and a defined offset between the indices of the non-contiguous subchannel for the second sidelink resource or the third sidelink resource.

As an illustrative example, the UE 115-a may receive the control signaling 220 that indicates an FRIV for multiple sidelink resources, where the FRIV is equal to 55. Further, the UE 115-a may also blindly detect a PSCCH in a subchannel 215. As such, the UE 115-a may identify that the FRIV value of 55 is mapped to the 1^{st} configured non-contiguous subchannel combination for the third sidelink resource as detailed in Table 9 and select 1^{st} configured non-contiguous subchannel combination for the third sidelink resource.

As such, the UE 115-a may add each index of the 1^{st} non-contiguous subchannel combination with the starting PSCCH subchannel index to obtain the non-contiguous subchannel combination for the second sidelink resource. That is, the UE 115-a may add the starting subchannel index of the PSCCH to each subchannel combination in Table 9, such that the subchannel combinations of Table 9 are relative to the starting subchannel index of the PSCCH.

In response to identifying the non-contiguous subchannel combination for the second sidelink resource and the non-contiguous subchannel combination for the third sidelink resource, the UE 115-a may select the non-contiguous subchannel combination for the first sidelink resource based on a quantity of subchannels of the non-contiguous subchannel combination for the second sidelink resource, the starting subchannel index of a PSCCH, and the defined offset between the indices of the non-contiguous subchannel for the second sidelink resource.

In response to identifying the defined offset, the UE 115-a may select the non-contiguous subchannel combination for the first sidelink resource, such that the non-contiguous subchannel combination for the first sidelink resource includes the same quantity of subchannels as the second sidelink resource, whose indices are separated by the defined offset, and includes the same starting subchannel index as the starting subchannel index of the PSCCH. In this way, the UE 115-a may select different non-contiguous sidelink combinations for three sidelink resources.

Alternatively, if absolute subchannel combinations are defined or preconfigured in the table, the UE 115-a may select the non-contiguous subchannel combination for the second sidelink resource and select the non-contiguous subchannel combination for the third sidelink resource based on the absolute mapping between FRIV and the non-contiguous subchannel combinations as detailed in Table 9. Based on selecting the non-contiguous subchannel combinations for the second sidelink resource and the third sidelink resource, the UE 115-a may select the non-contiguous subchannel combination for the first sidelink resource based on the starting subchannel index of the PSCCH and a quantity of subchannels indicated by the FRIV.

As an illustrative example, the UE 115-a may receive the control signaling 220 that indicates an FRIV for multiple sidelink resources, where the FRIV is equal to 55. Further, the UE 115-a may also blindly detect a PSCCH in a subchannel 215. As such, the UE 115-a may identify that the FRIV value of 55 is mapped to the 1^{st} configured non-contiguous subchannel combination for the second sidelink resource and the third sidelink resource as detailed in Table 9 and select 1^{st} configured non-contiguous subchannel combination for the second sidelink resource and the third sidelink resource.

As such, because the non-contiguous subchannel combination for the first sidelink resource is based on the non-contiguous subchannel combination for the second sidelink resource, the UE 115-a may select the non-contiguous subchannel combination for the first sidelink resource, such that the non-contiguous subchannel combination for the first sidelink resource has the same starting subchannel index as the PSCCH and includes the same quantity of subchannels as the second sidelink resource.

In some other examples, the second sidelink resource may include a non-contiguous subchannel combination, while the first sidelink resource may include a contiguous subchannel combination (e.g., mixed contiguous and non-contiguous subchannel combinations for different resources). That is, the relationship between the first sidelink resource and the second sidelink resource may indicate that the subchannel combination for the first sidelink resource is contiguous and the subchannel combination for the second sidelink resource is non-contiguous.

For example, a set of non-contiguous subchannel combinations may be predefined or preconfigured for the second sidelink resource, the third sidelink resource, or both in a table, where each entry in the table corresponds to a subchannel combination associated with the second sidelink resource, the third sidelink resource, or both (e.g., the table has entries for one or more future reserved resources). Each entry in the table may be mapped to a remaining value of the FRIV, such that a first entry in the table is mapped to a first remaining FRIV and a second entry in the table is mapped to the second remaining FRIV. That is, the FRIV may be an index to the table.

In such examples, the non-contiguous subchannel combinations in the table may correspond to absolute mapping between the FRIV and the subchannel combination indexes. That is, in the example of mixed contiguous and non-contiguous subchannel combinations, the UE 115-a may select the non-contiguous subchannel combination for the second sidelink resource from the table based on the FRIV, where the entries in the table correspond to an absolute mapping between the FRIV and the subchannel combinations.

Based on selecting the non-contiguous subchannel combination for the second sidelink resource, the UE 115-a may select the subchannel combination for the first sidelink resources. For example, for the first sidelink resource, the UE 115-a may select the starting subchannel index and quantity of subchannels based on the starting subchannel index of a PSCCH and the quantity of subchannels derived from FRIV. That is, the UE 115-a may select a contiguous subchannel combination that has a starting subchannel index that is the same as the starting subchannel index of PSCCH and that has a quantity of subchannels that is equal to the quantity of subchannels derived the FRIV.

In some examples, the subchannel combination for the first sidelink resource may be a contiguous subchannel combination or a non-contiguous subchannel combination by default or based on dynamic signaling. For example, the UE 115-a may select a contiguous subchannel combination for the first sidelink resource by default (e.g., as defined in the 3GPP standards). Alternatively, the UE 115-a may receive, via the control signaling 220 (e.g., RRC message or SCI), an indication of whether the subchannel combination for the first sidelink resource is to be a contiguous subchannel combination or a non-contiguous subchannel combination.

If the first sidelink resource includes contiguous subchannel combinations, then the UE 115-a may select, as the contiguous subchannel combination for the sidelink resource, a quantity of contiguous subchannels indicated by the FRIV (e.g., N_{subCH}) that start from the starting subchannel index of a PSCCH. As an illustrative example, if the UE 115-a detects the PSCCH in a subchannel 215 with an index of 1 and also receives, via the FRIV, an indication that the quantity of subchannels is 3, then the UE 115-a may select a subchannel 215 with the index of 1, a subchannel with the index of 2, and a subchannel with an index of 3 to be the contiguous subchannel combination for the first sidelink resource.

Otherwise, if the first sidelink resource includes a non-contiguous subchannel combination, the UE 115-a may select, from among the non-contiguous subchannel combinations configured for second sidelink resource or the third sidelink resource (e.g., from among the table defined for the second or third sidelink resource), a non-contiguous subchannel combination associated with the same starting subchannel index as PSCCH and having a same quantity of subchannels as indicated by FRIV.

As an illustrative example, the UE 115-a may receive, via the control signaling 220, an indication that the subchannel combination for the first sidelink resource is to include a non-contiguous subchannel combination. Further, the UE 115-a may also receive, via the control signaling 220, an indication that the quantity of subchannels is to be 2. As such, if the UE 115-a blindly detects that the starting subchannel index of a PSCCH is 1, then the UE 115-a may select a non-contiguous subchannel combination for the first sidelink resource that has a starting subchannel index of 1 and two subchannels.

Table 10 may be an example of a mapping between the remaining FRIV values and non-contiguous subchannel combinations for an RB set 205 that includes 10 subchannels 215 and when two sidelink resources are reserved (e.g., sl-MaxNumPerReserve=2).

TABLE 10
Mapping between remaining FRIVs and subchannel
combinations for 10 subchannels in the RB set
and quantity of reserved sidelink resources is 2.

| | | Subchannel |
|---|---|---|
| | Remaining | Combinations for |
| Row | FRIV | Second Resource |
| 0 | 55 | 0, 1 |
| 1 | 56 | 0, 1, 5, 6 |
| 2 | 57 | 1, 6 |
| 3 | 58 | 1, 2, 3, 4, 6, 7, 8, 9 |
| 4 | 59 | 2, 7 |
| 5 | 60 | 2, 3, 4, 7, 8, 9 |
| 6 | 61 | 3, 8 |
| 7 | 62 | 4, 9 |
| . . . | . . . | Reserved |

As an illustrative example, the UE 115-a may receive, via the control signaling 220, an indication of an FRIV that is set to 59. Further, the UE 115-a may detect a PSCCH with a starting subchannel index of 1. In such examples, the UE 115-a may identify the subchannel combination of {2,7} is associated with an FRIV of 59 and select the non-contiguous subchannel combination of {2,7} for the second sidelink resource. Additionally, the UE 115-a may identify, based on the FRIV of 59, that the quantity of subchannels for the first sidelink resource is two. That is, the UE 115-a may determine, based on the quantity of subchannels for the second sidelink resource, that the quantity of subchannels for the subchannel combination of the first sidelink resource is two.

In one example, the subchannel combination for the first sidelink resource may be a contiguous subchannel combination. As such, based on selecting the non-contiguous subchannel combination of {2,7}, the UE 115-a may select the contiguous subchannel combination of {1,2} for the first sidelink resource, such that the starting subchannel index of the first sidelink resource (e.g., 1) is equivalent to the starting subchannel index of the PSCCH (e.g., 1) and a quantity of subchannels for the first sidelink resource (e.g., two subchannels, with indices of 1 and 2) is equivalent to the quantity of subchannels indicated by the FRIV of 59 (e.g., 2 subchannels).

In another example, the subchannel combination for the first sidelink resource may be non-contiguous. In such examples, based on selecting the non-contiguous subchannel combination of {2,7}, the UE 115-a may select the non-contiguous subchannel combination of {1,6} from Table 10 for the first sidelink resource, such that the starting subchannel index of the first sidelink resource (e.g., 1) is equivalent to the starting subchannel index of the PSCCH (e.g., 1) and a quantity of subchannels for the first sidelink resource (e.g., two subchannels, with indices of 1 and 2) is equivalent to the quantity of subchannels indicated by the FRIV of 59 (e.g., 2 subchannels).

Table 11 may be an example of a mapping between the remaining FRIV values and non-contiguous subchannel combinations for an RB set 205 that includes 10 subchannels 215 and when three sidelink resources are reserved (e.g., sl-MaxNumPerReserve=3).

TABLE 11
Mapping between remaining FRIVs and subchannel
combinations for 10 subchannels in the RB set
and quantity of reserved sidelink resources is 3.

| | | Subchannel | Subchannel |
|---|---|---|---|
| | Remaining | Combinations for | Combinations for |
| Rows | FRIV | Second Resource | Third Resource |
| 0 | 385 | 0, 1 | 0, 5 |
| 1 | 386 | 1, 2 | 1, 6 |
| 2 | 387 | 2, 3 | 2, 7 |
| 3 | 388 | 3, 4 | 3, 8 |
| 4 | 389 | 4, 5 | 4, 9 |
| 5 | 390 | 0, 1, 5, 6 | 0, 1, 5, 6 |
| 6 | 391 | . . . | . . . |
| 7 | 392 | . . . | . . . |
| 8 | 393 | . . . | . . . |
| 9 | 394 | . . . | . . . |
| 10 | 395 | . . . | . . . |
| . . . | . . . | . . . | . . . |

As an illustrative example, the UE 115-a may receive, via the control signaling 220, an indication of an FRIV that is set to 387. Further, the UE 115-a may detect a PSCCH with a starting subchannel index of 1. In such examples, the UE 115-a may identify the subchannel combination of {2,3} is associated with an FRIV of 387 and select the contiguous subchannel combination of {2,3} for the second sidelink resource. Additionally, the UE 115-a may identify the subchannel combination of {2,7} is associated with an FRIV of 387 and select the non-contiguous subchannel combination of {2,7} for the third sidelink resource. The UE 115-a may identify, based on the FRIV of 387, that the quantity of subchannels for the first sidelink resource is two. That is, the UE 115-a may determine, based on the quantity of subchannels for the second sidelink resource, that the quantity of subchannels for the subchannel combination of the first sidelink resource is two.

In one example, the subchannel combination for the first sidelink resource may be a contiguous subchannel combination. As such, based on selecting the non-subchannel combination for the second sidelink resource and the third sidelink resource, the UE 115-a may select the contiguous subchannel combination of {1,2} for the first sidelink resource, such that the starting subchannel index of the first sidelink resource (e.g., 1) is equivalent to the starting subchannel index of the PSCCH (e.g., 1) and a quantity of subchannels for the first sidelink resource (e.g., two subchannels, with indices of 1 and 2) is equivalent to the quantity of subchannels indicated by the FRIV of 387 (e.g., 2 subchannels).

In another example, the subchannel combination for the first sidelink resource may be non-contiguous. In such examples based on selecting the non-subchannel combination for the second sidelink resource and the third sidelink resource, the UE 115-a may select the non-contiguous subchannel combination of {1,6} from Table 11 for the first sidelink resource, such that the starting subchannel index of the first sidelink resource (e.g., 1) is equivalent to the starting subchannel index of the PSCCH (e.g., 1) and a quantity of subchannels for the first sidelink resource (e.g., two subchannels, with indices of 1 and 2) is equivalent to the quantity of subchannels indicated by the FRIV of 387 (e.g., 2 subchannels).

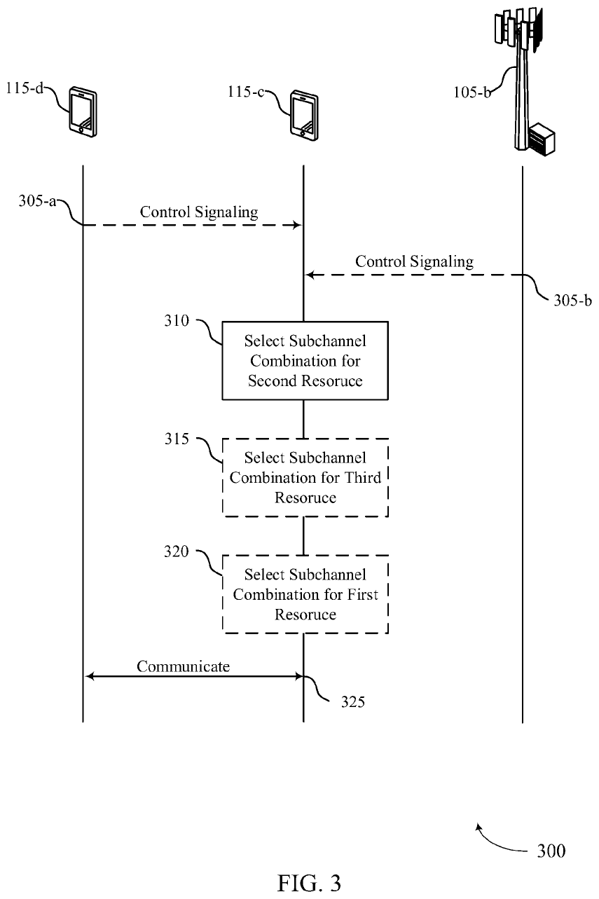

FIG. 3 shows an example of a process flow 300 that supports frequency resource allocation for non-contiguous subchannels in sidelink communications in accordance with one or more aspects of the present disclosure. Aspects of the process flow 300 may implement, or be implemented by, aspects of wireless communications system 100 and the wireless communications system 200 as described herein with reference to FIGS. 1 and 2. For example, the process flow 300 may include a UE 115-d and a network entity 105-b, which may be an example of the UE 115-b and a network entity 105-a, respectively, as described herein. Further, the process flow 300 may include a UE 115-c, which may be an example of the UE 115-a as described herein. The techniques described in the context of the process flow 300 may enable the UE 115-c to receive an indication of, and utilize, non-contiguous subchannel combinations for multiple sidelink resources in sidelink communications.

At 305-a or 305-b, the UE 115-c may receive control signaling (e.g., the control signaling 220) that indicates a frequency resource allocation (e.g., a FRIV) for at least a first sidelink resource and a second sidelink resource, where the frequency resource allocation indicates a non-contiguous subchannel combination for the second sidelink resource. In such examples, the control signaling may be SCI from the UE 115-d or an RRC message from the network entity 105-b.

At 310, the UE 115-c may select the non-contiguous subchannel combination for the second sidelink resource based on an index value of the frequency resource allocation (e.g., the FRIV), which may be included in the control signaling. In such examples, the UE 115-c may map the index value of the frequency resource allocation to multiple subchannel combinations and select the non-contiguous subchannel combination for the second sidelink resource based on the mapping. That is, the UE 115-c may identify the subchannel combination for the second sidelink resource using one of the Tables 2 through 11 as described herein with reference to FIG. 2.

At 315, if the quantity of reserved sidelink resources is three (e.g., sl-MaxNumPerReserve=3), then the UE 115-c may select a subchannel combination for a third sidelink resource of the multiple sidelink resource using the techniques described herein with reference to FIG. 3.

At 320, in response to selecting the subchannel combinations for the second sidelink resource, the third sidelink resource, or both, the UE 115-c may select the subchannel combination for the first sidelink resource based on a relationship between the first sidelink resource and the second sidelink resource as described herein with reference to FIG. 2. In one example, the same non-contiguous subchannel combination may be used for each of the reserved resources. That is, the relationship between the first sidelink resource and the second sidelink resource may be the non-contiguous subchannel combination for the second sidelink resource is applied to each of the multiple sidelink resources.

In some other examples, each of the reserved sidelink resources may have different non-contiguous subchannel combinations, where each non-contiguous subchannel combination for the multiple sidelink resources have the same quantity of subchannels. That is, the relationship between the first sidelink resource and the second sidelink resource may be that each of the multiple sidelink resources are associated with a respective non-contiguous subchannel combination that have the same quantity of subchannels and quantity of subchannel indices.

Additionally, or alternatively, the second sidelink resource may include a non-contiguous subchannel combination, while the first sidelink resource may include a contiguous subchannel combination (e.g., mixed contiguous and non-contiguous subchannel combinations for different resources). That is, the relationship between the first sidelink resource and the second sidelink resource may indicate that the subchannel combination for the first sidelink resource is contiguous and the subchannel combination for the second sidelink resource is non-contiguous, or vice versa.

At 325, based on selecting (e.g., identifying, determining, or the like) the subchannel combinations for the multiple sidelink resources, the UE 115-c may communicate with the UE 115-d via PSSCH using the multiple sidelink resources.

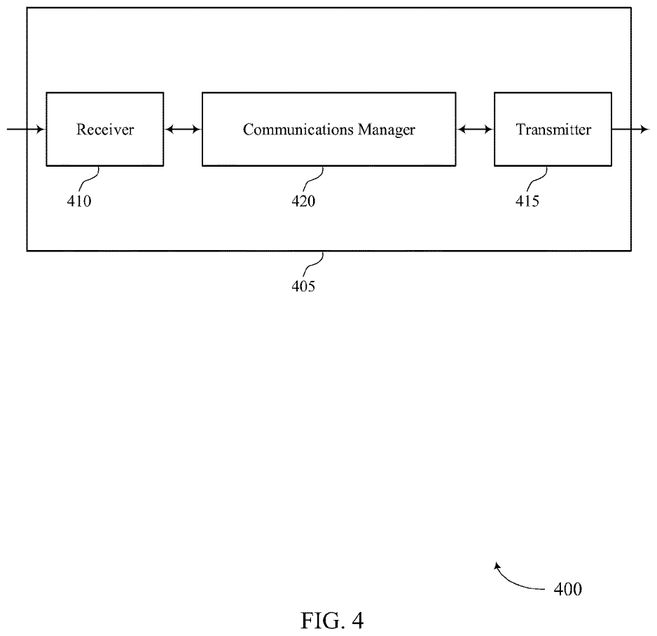

FIG. 4 shows a block diagram 400 of a device 405 that supports frequency resource allocation for non-contiguous subchannels in sidelink communications in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, and the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to frequency resource allocation for non-contiguous subchannels in sidelink communications). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to frequency resource allocation for non-contiguous subchannels in sidelink communications). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of frequency resource allocation for non-contiguous subchannels in sidelink communications as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor. If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications by a UE in accordance with examples as disclosed herein. For example, the communications manager 420 is capable of, configured to, or operable to support a means for receiving control signaling that indicates a frequency resource allocation for multiple sidelink resources, the multiple sidelink resources including at least a first sidelink resource and a second sidelink resource, where the frequency resource allocation indicates a non-contiguous subchannel combination for the second sidelink resource of the multiple sidelink resources. The communications manager 420 is capable of, configured to, or operable to support a means for communicating via a sidelink channel using at least the first sidelink resource and the second sidelink resource of the multiple sidelink resources, where a subchannel combination for the first sidelink resource is based on a relationship between the first sidelink resource and the second sidelink resource and on a quantity of the multiple sidelink resources.

Additionally, or alternatively, the communications manager 420 may support wireless communications by a UE in accordance with examples as disclosed herein. For example, the communications manager 420 is capable of, configured to, or operable to support a means for transmitting control signaling that indicates a frequency resource allocation for multiple sidelink resources, the multiple sidelink resources including at least a first sidelink resource and a second sidelink resource, where the frequency resource allocation indicates a non-contiguous subchannel combination for the second sidelink resource of the multiple sidelink resources. The communications manager 420 is capable of, configured to, or operable to support a means for communicating via a sidelink channel using at least the first sidelink resource and the second sidelink resource of the multiple sidelink resources, where a subchannel combination for the first sidelink resource is based on a relationship between the second sidelink resource and the first sidelink resource and on a quantity of the multiple sidelink resources.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for indicating non-contiguous subchannel combinations for multiple sidelink resources, which may provide for more efficient utilization of communication resources.

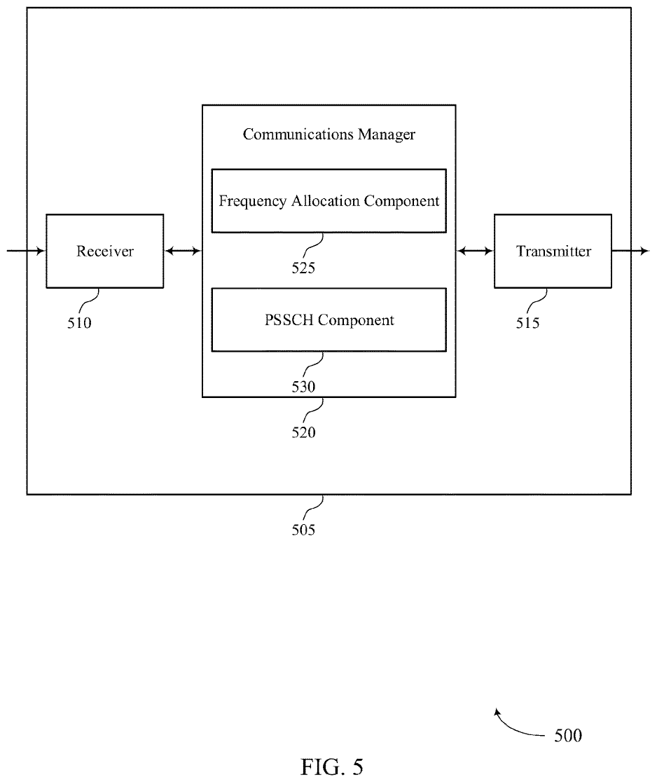

FIG. 5 shows a block diagram 500 of a device 505 that supports frequency resource allocation for non-contiguous subchannels in sidelink communications in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, and the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to frequency resource allocation for non-contiguous subchannels in sidelink communications). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to frequency resource allocation for non-contiguous subchannels in sidelink communications). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of frequency resource allocation for non-contiguous subchannels in sidelink communications as described herein. For example, the communications manager 520 may include a frequency allocation component 525 an PSSCH component 530, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications by a UE in accordance with examples as disclosed herein. The frequency allocation component 525 is capable of, configured to, or operable to support a means for receiving control signaling that indicates a frequency resource allocation for multiple sidelink resources, the multiple sidelink resources including at least a first sidelink resource and a second sidelink resource, where the frequency resource allocation indicates a non-contiguous subchannel combination for the second sidelink resource of the multiple sidelink resources. The PSSCH component 530 is capable of, configured to, or operable to support a means for communicating via a sidelink channel using at least the first sidelink resource and the second sidelink resource of the multiple sidelink resources, where a subchannel combination for the first sidelink resource is based on a relationship between the first sidelink resource and the second sidelink resource and on a quantity of the multiple sidelink resources.

Additionally, or alternatively, the communications manager 520 may support wireless communications by a UE in accordance with examples as disclosed herein. The frequency allocation component 525 is capable of, configured to, or operable to support a means for transmitting control signaling that indicates a frequency resource allocation for multiple sidelink resources, the multiple sidelink resources including at least a first sidelink resource and a second sidelink resource, where the frequency resource allocation indicates a non-contiguous subchannel combination for the second sidelink resource of the multiple sidelink resources. The PSSCH component 530 is capable of, configured to, or operable to support a means for communicating via a sidelink channel using at least the first sidelink resource and the second sidelink resource of the multiple sidelink resources, where a subchannel combination for the first sidelink resource is based on a relationship between the second sidelink resource and the first sidelink resource and on a quantity of the multiple sidelink resources.

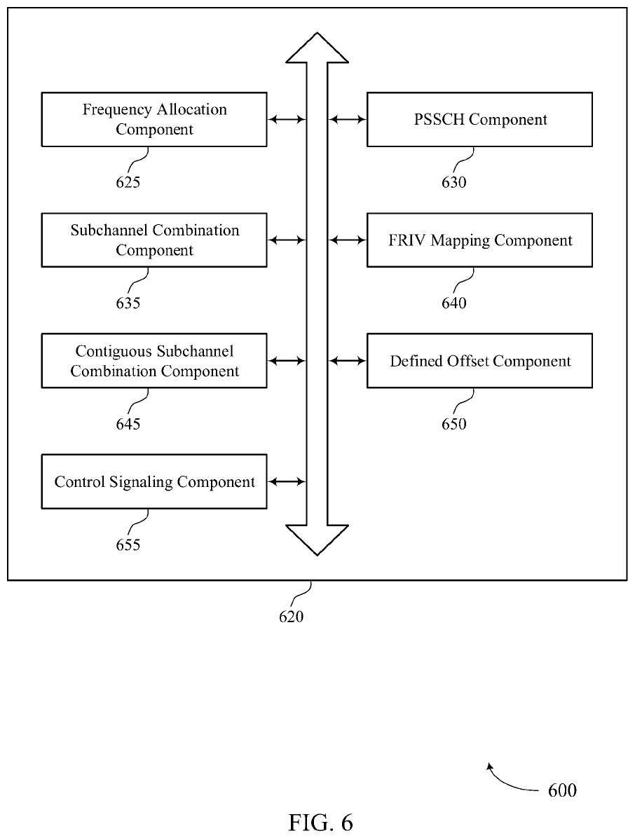

FIG. 6 shows a block diagram 600 of a communications manager 620 that supports frequency resource allocation for non-contiguous subchannels in sidelink communications in accordance with one or more aspects of the present disclosure. The communications manager 620 may be an example of aspects of a communications manager 420, a communications manager 520, or both, as described herein. The communications manager 620, or various components thereof, may be an example of means for performing various aspects of frequency resource allocation for non-contiguous subchannels in sidelink communications as described herein. For example, the communications manager 620 may include a frequency allocation component 625, an PSSCH component 630, a subchannel combination component 635, a FRIV mapping component 640, a contiguous subchannel combination component 645, a defined offset component 650, a control signaling component 655, or any combination thereof. Each of these components, or components or subcomponents thereof (e.g., one or more processors, one or more memories), may communicate, directly or indirectly, with one another (e.g., via one or more buses).

The communications manager 620 may support wireless communications by a UE in accordance with examples as disclosed herein. The frequency allocation component 625 is capable of, configured to, or operable to support a means for receiving control signaling that indicates a frequency resource allocation for multiple sidelink resources, the multiple sidelink resources including at least a first sidelink resource and a second sidelink resource, where the frequency resource allocation indicates a non-contiguous subchannel combination for the second sidelink resource of the multiple sidelink resources. The PSSCH component 630 is capable of, configured to, or operable to support a means for communicating via a sidelink channel using at least the first sidelink resource and the second sidelink resource of the multiple sidelink resources, where a subchannel combination for the first sidelink resource is based on a relationship between the first sidelink resource and the second sidelink resource and on a quantity of the multiple sidelink resources.

In some examples, the subchannel combination component 635 is capable of, configured to, or operable to support a means for selecting the non-contiguous subchannel combination for the second sidelink resource based on an index value associated with the frequency resource allocation and included in the control signaling.

In some examples, the FRIV mapping component 640 is capable of, configured to, or operable to support a means for mapping the index value associated with the frequency resource allocation to one of a set of multiple subchannel combinations, where selecting the non-contiguous subchannel combination for the second sidelink resource is based on mapping the index value to one of the set of multiple subchannel combinations.

In some examples, the subchannel combination component 635 is capable of, configured to, or operable to support a means for selecting the non-contiguous subchannel combination for the second sidelink resource as the subchannel combination for the first sidelink resource, where the relationship between the second sidelink resource and the first sidelink resource includes the non-contiguous subchannel combination for the second sidelink resource being applied to each of the multiple sidelink resources.

In some examples, the subchannel combination component 635 is capable of, configured to, or operable to support a means for selecting a second non-contiguous subchannel combination as the subchannel combination for the first sidelink resource, where the relationship between the second sidelink resource and the first sidelink resource includes that each of the multiple sidelink resources are associated with a respective non-contiguous subchannel combination.

In some examples, selecting the second non-contiguous subchannel combination for the first sidelink resource is based on a starting subchannel index of a PSCCH and a defined offset.

In some examples, the defined offset component 650 is capable of, configured to, or operable to support a means for calculating a difference between a first index of a first subchannel of the non-contiguous subchannel combination for the second sidelink resource and a second index of a second subchannel of the non-contiguous subchannel combination for the second sidelink resource, where the defined offset is based on the difference.

In some examples, the control signaling component 655 is capable of, configured to, or operable to support a means for receiving, via the control signaling, an indication of the defined offset.

In some examples, selecting the second non-contiguous subchannel combination is based on a starting subchannel index of a PSCCH and a quantity of subchannels indicated via the frequency resource allocation.

In some examples, the second non-contiguous subchannel combination has a same starting subchannel index of the PSCCH and a same quantity of subchannels as the non-contiguous subchannel combination for the second sidelink resource.

In some examples, the subchannel combination component 635 is capable of, configured to, or operable to support a means for receiving, via the control signaling, an indication of the second non-contiguous subchannel combination for the first sidelink resource, where the second non-contiguous subchannel combination is selected based on the indication.

In some examples, the subchannel combination for the first sidelink resource is a contiguous subchannel combination.

In some examples, the contiguous subchannel combination component 645 is capable of, configured to, or operable to support a means for receiving, via the control signaling, an indication of the contiguous subchannel combination.

In some examples, the contiguous subchannel combination is based on a starting subchannel index of a PSCCH and a quantity of subchannels indicated via the frequency resource allocation.

In some examples, selecting the non-contiguous subchannel combination for the second sidelink resource is further based on a starting subchannel index of a PSCCH.

In some examples, selecting the non-contiguous subchannel combination for the second sidelink resource is further based on a quantity of subchannels for the second sidelink resource and a quantity of subchannel indexes of the non-contiguous subchannel combination for the second sidelink resource.

In some examples, a quantity of bits of the index value of the frequency resource allocation is based on a quantity of a set of multiple contiguous subchannel combinations for the multiple sidelink resources and a quantity of a set of multiple non-contiguous subchannel combinations for the multiple sidelink resources.

Additionally, or alternatively, the communications manager 620 may support wireless communications by a UE in accordance with examples as disclosed herein. In some examples, the frequency allocation component 625 is capable of, configured to, or operable to support a means for transmitting control signaling that indicates a frequency resource allocation for multiple sidelink resources, the multiple sidelink resources including at least a first sidelink resource and a second sidelink resource, where the frequency resource allocation indicates a non-contiguous subchannel combination for the second sidelink resource of the multiple sidelink resources. In some examples, the PSSCH component 630 is capable of, configured to, or operable to support a means for communicating via a sidelink channel using at least the first sidelink resource and the second sidelink resource of the multiple sidelink resources, where a subchannel combination for the first sidelink resource is based on a relationship between the second sidelink resource and the first sidelink resource and on a quantity of the multiple sidelink resources.

In some examples, the non-contiguous subchannel combination for the second sidelink resource is based on an index value of the frequency resource allocation.

In some examples, the subchannel combination for the first sidelink resource is equivalent to the non-contiguous subchannel combination for the second sidelink resource.

In some examples, the non-contiguous subchannel combination for the second sidelink resource is further based on a starting subchannel index of a PSCCH.

In some examples, the relationship between the second sidelink resource and the first sidelink resource includes the subchannel combination of the first sidelink resource being non-contiguous and being different from the non-contiguous subchannel combination of the second sidelink resource.

In some examples, a second non-contiguous subchannel combination for the first sidelink resource is based on a starting subchannel index of a PSCCH and a defined offset.

In some examples, the defined offset is a difference between a first index of a first subchannel of the non-contiguous subchannel combination for the second sidelink resource and a second index of a second subchannel of the non-contiguous subchannel combination for the second sidelink resource, and an offset of the second non-contiguous subchannel combination for the first sidelink resource is equivalent to the defined offset.

In some examples, the control signaling component 655 is capable of, configured to, or operable to support a means for transmitting, via the control signaling, an indication of the defined offset.

In some examples, a second non-contiguous subchannel combination is based on a starting subchannel index of a PSCCH and a quantity of subchannels indicated via the frequency resource allocation.

In some examples, the second non-contiguous subchannel combination for the first sidelink resource has a same starting subchannel index of the PSCCH and a same quantity of subchannels as the non-contiguous subchannel combination for the second sidelink resource.

In some examples, the subchannel combination component 635 is capable of, configured to, or operable to support a means for transmitting, via the control signaling, an indication of the second non-contiguous subchannel combination for the first sidelink resource.

In some examples, the subchannel combination for the first sidelink resource is a contiguous subchannel combination.

In some examples, the contiguous subchannel combination component 645 is capable of, configured to, or operable to support a means for transmitting, via the control signaling, an indication of the contiguous subchannel combination.

In some examples, the contiguous subchannel combination is based on a starting subchannel index of a PSCCH and a quantity of subchannels indicated via the frequency resource allocation.

In some examples, the non-contiguous subchannel combination for the second sidelink resource is further based on a starting subchannel index of a PSCCH.

In some examples, the non-contiguous subchannel combination for the second sidelink resource is further based on a quantity of subchannels for the second sidelink resource and a quantity of subchannel indexes of the non-contiguous subchannel combination for the second sidelink resource.

In some examples, a quantity of bits of the index value of the frequency resource allocation is based on a quantity of a set of multiple contiguous subchannel combinations for the multiple sidelink resources and a quantity of a set of multiple non-contiguous subchannel combinations for the multiple sidelink resources.

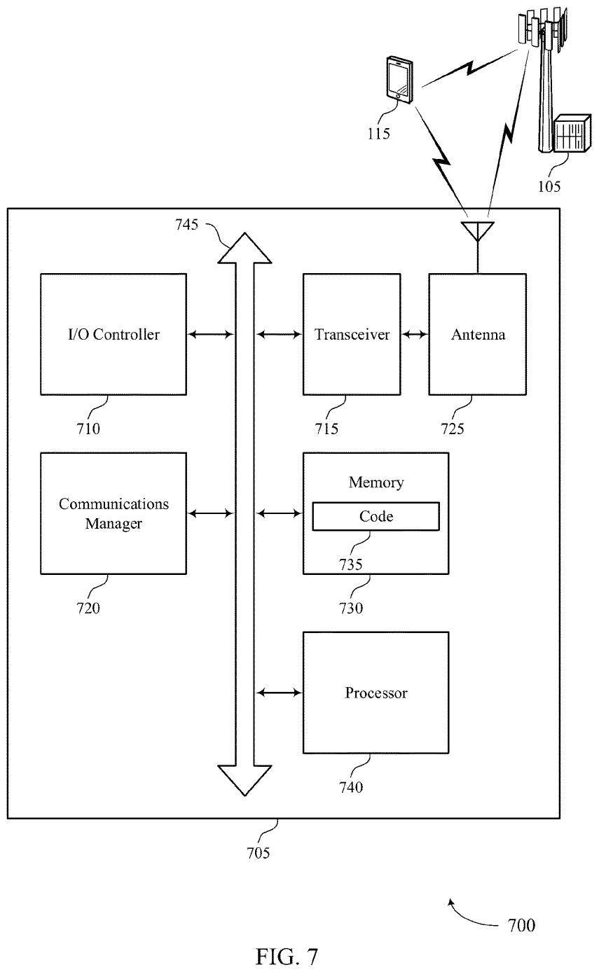

FIG. 7 shows a diagram of a system 700 including a device 705 that supports frequency resource allocation for non-contiguous subchannels in sidelink communications in accordance with one or more aspects of the present disclosure. The device 705 may be an example of or include the components of a device 405, a device 505, or a UE 115 as described herein. The device 705 may communicate (e.g., wirelessly) with one or more network entities 105, one or more UEs 115, or any combination thereof. The device 705 may include components for bi-directional voice and data communications including components for transmitting and receiving communications, such as a communications manager 720, an input/output (I/O) controller 710, a transceiver 715, an antenna 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable code 735 including instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may contain, among other things, a basic I/O system (BIOS) which may control basic hardware or software operation such as the interaction with peripheral components or devices.

The at least one processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting frequency resource allocation for non-contiguous subchannels in sidelink communications). For example, the device 705 or a component of the device 705 may include at least one processor 740 and at least one memory 730 coupled with or to the at least one processor 740, the at least one processor 740 and at least one memory 730 configured to perform various functions described herein. In some examples, the at least one processor 740 may include multiple processors and the at least one memory 730 may include multiple memories. One or more of the multiple processors may be coupled with one or more of the multiple memories, which may, individually or collectively, be configured to perform various functions herein.

The communications manager 720 may support wireless communications by a UE in accordance with examples as disclosed herein. For example, the communications manager 720 is capable of, configured to, or operable to support a means for receiving control signaling that indicates a frequency resource allocation for multiple sidelink resources, the multiple sidelink resources including at least a first sidelink resource and a second sidelink resource, where the frequency resource allocation indicates a non-contiguous subchannel combination for the second sidelink resource of the multiple sidelink resources. The communications manager 720 is capable of, configured to, or operable to support a means for communicating via a sidelink channel using at least the first sidelink resource and the second sidelink resource of the multiple sidelink resources, where a subchannel combination for the first sidelink resource is based on a relationship between the first sidelink resource and the second sidelink resource and on a quantity of the multiple sidelink resources.

Additionally, or alternatively, the communications manager 720 may support wireless communications by a UE in accordance with examples as disclosed herein. For example, the communications manager 720 is capable of, configured to, or operable to support a means for transmitting control signaling that indicates a frequency resource allocation for multiple sidelink resources, the multiple sidelink resources including at least a first sidelink resource and a second sidelink resource, where the frequency resource allocation indicates a non-contiguous subchannel combination for the second sidelink resource of the multiple sidelink resources. The communications manager 720 is capable of, configured to, or operable to support a means for communicating via a sidelink channel using at least the first sidelink resource and the second sidelink resource of the multiple sidelink resources, where a subchannel combination for the first sidelink resource is based on a relationship between the second sidelink resource and the first sidelink resource and on a quantity of the multiple sidelink resources.

By including or configuring the communications manager 720 in accordance with examples as described herein, the device 705 may support techniques for indicating non-contiguous subchannel combinations for multiple sidelink resources, which may provide for a more efficient utilization of communication resources and increased transmission power in sidelink communications.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of frequency resource allocation for non-contiguous subchannels in sidelink communications as described herein, or the at least one processor 740 and the at least one memory 730 may be otherwise configured to, individually or collectively, perform or support such operations.

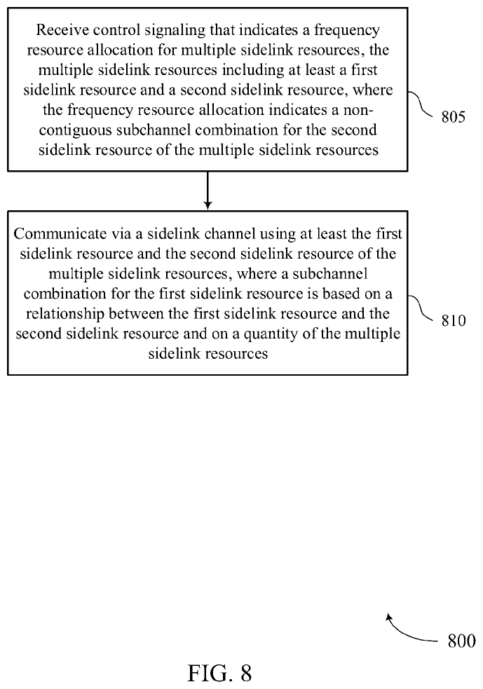

FIG. 8 shows a flowchart illustrating a method 800 that supports frequency resource allocation for non-contiguous subchannels in sidelink communications in accordance with aspects of the present disclosure. The operations of the method 800 may be implemented by a UE or its components as described herein. For example, the operations of the method 800 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 805, the method may include receiving control signaling that indicates a frequency resource allocation for multiple sidelink resources, the multiple sidelink resources including at least a first sidelink resource and a second sidelink resource, where the frequency resource allocation indicates a non-contiguous subchannel combination for the second sidelink resource of the multiple sidelink resources. The operations of block 805 may be performed in accordance with examples as disclosed herein. In some examples, aspects of the operations of 805 may be performed by a frequency allocation component 625 as described with reference to FIG. 6.

At 810, the method may include communicating via a sidelink channel using at least the first sidelink resource and the second sidelink resource of the multiple sidelink resources, where a subchannel combination for the first sidelink resource is based on a relationship between the first sidelink resource and the second sidelink resource and on a quantity of the multiple sidelink resources. The operations of block 810 may be performed in accordance with examples as disclosed herein. In some examples, aspects of the operations of 810 may be performed by an PSSCH component 630 as described with reference to FIG. 6.

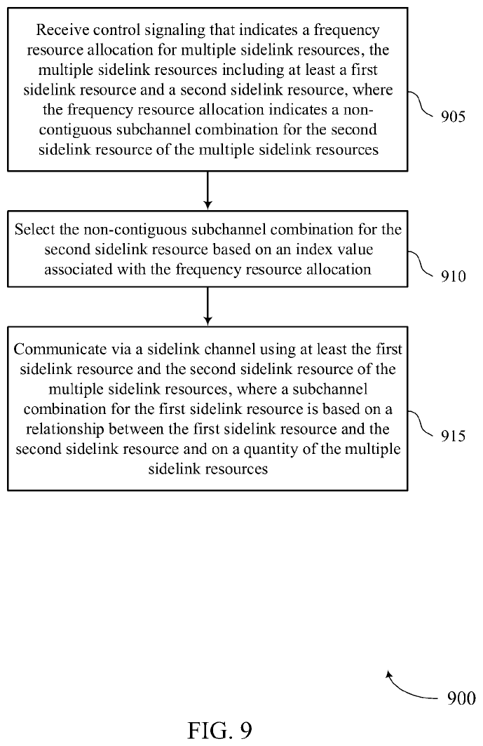

FIG. 9 shows a flowchart illustrating a method 900 that supports frequency resource allocation for non-contiguous subchannels in sidelink communications in accordance with aspects of the present disclosure. The operations of the method 900 may be implemented by a UE or its components as described herein. For example, the operations of the method 900 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 905, the method may include receiving control signaling that indicates a frequency resource allocation for multiple sidelink resources, the multiple sidelink resources including at least a first sidelink resource and a second sidelink resource, where the frequency resource allocation indicates a non-contiguous subchannel combination for the second sidelink resource of the multiple sidelink resources. The operations of block 905 may be performed in accordance with examples as disclosed herein. In some examples, aspects of the operations of 905 may be performed by a frequency allocation component 625 as described with reference to FIG. 6.

At 910, the method may include selecting the non-contiguous subchannel combination for the second sidelink resource based on an index value associated with the frequency resource allocation. The operations of block 910 may be performed in accordance with examples as disclosed herein. In some examples, aspects of the operations of 910 may be performed by a subchannel combination component 635 as described with reference to FIG. 6.

At 915, the method may include communicating via a sidelink channel using at least the first sidelink resource and the second sidelink resource of the multiple sidelink resources, where a subchannel combination for the first sidelink resource is based on a relationship between the first sidelink resource and the second sidelink resource and on a quantity of the multiple sidelink resources. The operations of block 915 may be performed in accordance with examples as disclosed herein. In some examples, aspects of the operations of 915 may be performed by an PSSCH component 630 as described with reference to FIG. 6.

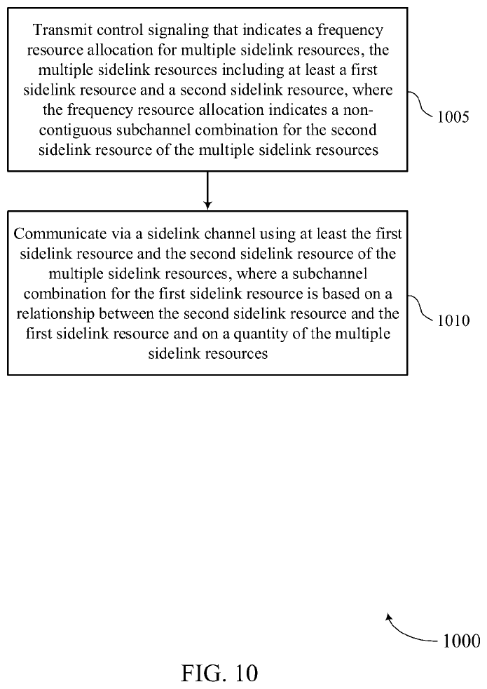

FIG. 10 shows a flowchart illustrating a method 1000 that supports frequency resource allocation for non-contiguous subchannels in sidelink communications in accordance with aspects of the present disclosure. The operations of the method 1000 may be implemented by a UE or its components as described herein. For example, the operations of the method 1000 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1005, the method may include transmitting control signaling that indicates a frequency resource allocation for multiple sidelink resources, the multiple sidelink resources including at least a first sidelink resource and a second sidelink resource, where the frequency resource allocation indicates a non-contiguous subchannel combination for the second sidelink resource of the multiple sidelink resources. The operations of block 1005 may be performed in accordance with examples as disclosed herein. In some examples, aspects of the operations of 1005 may be performed by a frequency allocation component 625 as described with reference to FIG. 6.

At 1010, the method may include communicating via a sidelink channel using at least the first sidelink resource and the second sidelink resource of the multiple sidelink resources, where a subchannel combination for the first sidelink resource is based on a relationship between the second sidelink resource and the first sidelink resource and on a quantity of the multiple sidelink resources. The operations of block 1010 may be performed in accordance with examples as disclosed herein. In some examples, aspects of the operations of 1010 may be performed by an PSSCH component 630 as described with reference to FIG. 6.

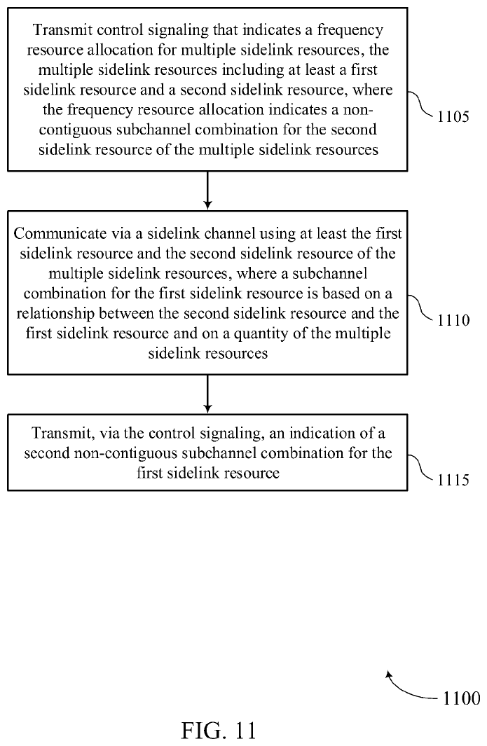

FIG. 11 shows a flowchart illustrating a method 1100 that supports frequency resource allocation for non-contiguous subchannels in sidelink communications in accordance with aspects of the present disclosure. The operations of the method 1100 may be implemented by a UE or its components as described herein. For example, the operations of the method 1100 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1105, the method may include transmitting control signaling that indicates a frequency resource allocation for multiple sidelink resources, the multiple sidelink resources including at least a first sidelink resource and a second sidelink resource, where the frequency resource allocation indicates a non-contiguous subchannel combination for the second sidelink resource of the multiple sidelink resources. The operations of block 1105 may be performed in accordance with examples as disclosed herein. In some examples, aspects of the operations of 1105 may be performed by a frequency allocation component 625 as described with reference to FIG. 6.

At 1110, the method may include communicating via a sidelink channel using at least the first sidelink resource and the second sidelink resource of the multiple sidelink resources, where a subchannel combination for the first sidelink resource is based on a relationship between the second sidelink resource and the first sidelink resource and on a quantity of the multiple sidelink resources. The operations of block 1110 may be performed in accordance with examples as disclosed herein. In some examples, aspects of the operations of 1110 may be performed by an PSSCH component 630 as described with reference to FIG. 6.

At 1115, the method may include transmitting, via the control signaling, an indication of the second non-contiguous subchannel combination for the first sidelink resource. The operations of block 1115 may be performed in accordance with examples as disclosed herein. In some examples, aspects of the operations of 1115 may be performed by a subchannel combination component 635 as described with reference to FIG. 6.

The following provides an overview of aspects of the present disclosure:
Aspect 1: A method for wireless communications by a UE, comprising: receiving control signaling that indicates a frequency resource allocation for multiple sidelink resources, the multiple sidelink resources including at least a first sidelink resource and a second sidelink resource, wherein the frequency resource allocation indicates a non-contiguous subchannel combination for the second sidelink resource of the multiple sidelink resources; and communicating via a sidelink channel using at least the first sidelink resource and the second sidelink resource of the multiple sidelink resources, wherein a subchannel combination for the first sidelink resource is based at least in part on a relationship between the first sidelink resource and the second sidelink resource and on a quantity of the multiple sidelink resources.
Aspect 2: The method of aspect 1, wherein the control signaling indicates an index value associated with the frequency resource allocation for selecting the non-contiguous subchannel combination for the second sidelink resource, and further comprising: selecting the non-contiguous subchannel combination for the second sidelink resource based at least in part on the index value associated with the frequency resource allocation.
Aspect 3: The method of aspect 2, further comprising: mapping the index value associated with the frequency resource allocation to one of a plurality of subchannel combinations, wherein selecting the non-contiguous subchannel combination for the second sidelink resource is based at least in part on mapping the index value to one of the plurality of subchannel combinations.
Aspect 4: The method of any of aspects 2 through 3, further comprising: selecting the non-contiguous subchannel combination for the second sidelink resource as the subchannel combination for the first sidelink resource, wherein the relationship between the second sidelink resource and the first sidelink resource comprises the non-contiguous subchannel combination for the second sidelink resource being applied to each of the multiple sidelink resources.
Aspect 5: The method of any of aspects 2 through 4, further comprising: selecting a second non-contiguous subchannel combination as the subchannel combination for the first sidelink resource, wherein the relationship between the second sidelink resource and the first sidelink resource comprises that each of the multiple sidelink resources are associated with a respective non-contiguous subchannel combination.
Aspect 6: The method of aspect 5, wherein selecting the second non-contiguous subchannel combination for the first sidelink resource is based at least in part on a starting subchannel index of a PSCCH and a defined offset.
Aspect 7: The method of aspect 6, further comprising: calculating a difference between a first index of a first subchannel of the non-contiguous subchannel combination for the second sidelink resource and a second index of a second subchannel of the non-contiguous subchannel combination for the second sidelink resource, wherein the defined offset is based at least in part on the difference.
Aspect 8: The method of any of aspects 6 through 7, further comprising: receiving, via the control signaling, an indication of the defined offset.
Aspect 9: The method of any of aspects 5 through 8, wherein selecting the second non-contiguous subchannel combination is based at least in part on a starting subchannel index of a PSCCH and a quantity of subchannels indicated via the frequency resource allocation.
Aspect 10: The method of aspect 9, wherein the second non-contiguous subchannel combination has a same starting subchannel index of the PSCCH and a same quantity of subchannels as the non-contiguous subchannel combination for the second sidelink resource.
Aspect 11: The method of any of aspects 9 through 10, further comprising: receiving, via the control signaling, an indication of the second non-contiguous subchannel combination for the first sidelink resource, wherein the second non-contiguous subchannel combination is selected based on the indication.
Aspect 12: The method of any of aspects 2 through 11, wherein the subchannel combination for the first sidelink resource is a contiguous subchannel combination.
Aspect 13: The method of aspect 12, further comprising: receiving, via the control signaling, an indication of the contiguous subchannel combination.
Aspect 14: The method of any of aspects 12 through 13, wherein the contiguous subchannel combination is based at least in part on a starting subchannel index of a PSCCH and a quantity of subchannels indicated via the frequency resource allocation.
Aspect 15: The method of any of aspects 2 through 14, wherein selecting the non-contiguous subchannel combination for the second sidelink resource is further based at least in part on a starting subchannel index of a PSCCH.
Aspect 16: The method of any of aspects 2 through 15, wherein selecting the non-contiguous subchannel combination for the second sidelink resource is further based at least in part on a quantity of subchannels for the second sidelink resource and a quantity of subchannel indexes of the non-contiguous subchannel combination for the second sidelink resource.
Aspect 17: The method of any of aspects 2 through 16, wherein a quantity of bits of the index value of the frequency resource allocation is based at least in part on a quantity of a plurality of contiguous subchannel combinations for the multiple sidelink resources and a quantity of a plurality of non-contiguous subchannel combinations for the multiple sidelink resources.
Aspect 18: A method for wireless communications by a UE, comprising: transmitting control signaling that indicates a frequency resource allocation for multiple sidelink resources, the multiple sidelink resources including at least a first sidelink resource and a second sidelink resource, wherein the frequency resource allocation indicates a non-contiguous subchannel combination for the second sidelink resource of the multiple sidelink resources; and communicating via a sidelink channel using at least the first sidelink resource and the second sidelink resource of the multiple sidelink resources, wherein a subchannel combination for the first sidelink resource is based at least in part on a relationship between the second sidelink resource and the first sidelink resource and on a quantity of the multiple sidelink resources.
Aspect 19: The method of aspect 18, wherein the non-contiguous subchannel combination for the second sidelink resource is based at least in part on an index value of the frequency resource allocation.
Aspect 20: The method of aspect 19, wherein the subchannel combination for the first sidelink resource is equivalent to the non-contiguous subchannel combination for the second sidelink resource.
Aspect 21: The method of any of aspects 19 through 20, wherein the non-contiguous subchannel combination for the second sidelink resource is further based at least in part on a starting subchannel index of a PSCCH.
Aspect 22: The method of any of aspects 19 through 21, wherein the relationship between the second sidelink resource and the first sidelink resource comprises the subchannel combination of the first sidelink resource being non-contiguous and being different from the non-contiguous subchannel combination of the second sidelink resource.
Aspect 23: The method of aspect 22, wherein a second non-contiguous subchannel combination for the first sidelink resource is based at least in part on a starting subchannel index of a PSCCH and a defined offset.
Aspect 24: The method of aspect 23, wherein the defined offset is a difference between a first index of a first subchannel of the non-contiguous subchannel combination for the second sidelink resource and a second index of a second subchannel of the non-contiguous subchannel combination for the second sidelink resource, and an offset of the second non-contiguous subchannel combination for the first sidelink resource is equivalent to the defined offset.
Aspect 25: The method of any of aspects 23 through 24, further comprising: transmitting, via the control signaling, an indication of the defined offset.
Aspect 26: The method of any of aspects 22 through 25, wherein a second non-contiguous subchannel combination is based at least in part on a starting subchannel index of a PSCCH and a quantity of subchannels indicated via the frequency resource allocation.
Aspect 27: The method of aspect 26, wherein the second non-contiguous subchannel combination for the first sidelink resource has a same starting subchannel index of the PSCCH and a same quantity of subchannels as the non-contiguous subchannel combination for the second sidelink resource.
Aspect 28: The method of any of aspects 26 through 27, further comprising: transmitting, via the control signaling, an indication of the second non-contiguous subchannel combination for the first sidelink resource.
Aspect 29: The method of any of aspects 19 through 28, wherein the subchannel combination for the first sidelink resource is a contiguous subchannel combination.
Aspect 30: The method of aspect 29, further comprising: transmitting, via the control signaling, an indication of the contiguous subchannel combination.
Aspect 31: The method of any of aspects 29 through 30, wherein the contiguous subchannel combination is based at least in part on a starting subchannel index of a PSCCH and a quantity of subchannels indicated via the frequency resource allocation.
Aspect 32: The method of any of aspects 29 through 31, wherein the non-contiguous subchannel combination for the second sidelink resource is further based at least in part on a starting subchannel index of a PSCCH.
Aspect 33: The method of any of aspects 19 through 32, wherein the non-contiguous subchannel combination for the second sidelink resource is further based at least in part on a quantity of subchannels for the second sidelink resource and a quantity of subchannel indexes of the non-contiguous subchannel combination for the second sidelink resource.
Aspect 34: The method of any of aspects 19 through 33, wherein a quantity of bits of the index value of the frequency resource allocation is based at least in part on a quantity of a plurality of contiguous subchannel combinations for the multiple sidelink resources and a quantity of a plurality of non-contiguous subchannel combinations for the multiple sidelink resources.
Aspect 35: A UE for wireless communication, comprising one or more memories storing processor-executable code; and one or more processors coupled with the one or more memories and individually or collectively operable to execute the code to cause the UE to perform a method of any of aspects 1 through 17.
Aspect 36: A UE for wireless communication, comprising at least one means for performing a method of any of aspects 1 through 17.
Aspect 37: A non-transitory computer-readable medium storing code for wireless communications, the code comprising instructions executable by one or more processors to perform a method of any of aspects 1 through 17.
Aspect 38: A UE for wireless communication, comprising one or more memories storing processor-executable code; and one or more processors coupled with the one or more memories and individually or collectively operable to execute the code to cause the UE to perform a method of any of aspects 18 through 34.
Aspect 39: A UE for wireless communication, comprising at least one means for performing a method of any of aspects 18 through 34.
Aspect 40: A non-transitory computer-readable medium storing code for wireless communications, the code comprising instructions executable by one or more processors to perform a method of any of aspects 18 through 34.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

Also, as used herein, the phrase “a set” shall be construed as including the possibility of a set with one member. That is, the phrase “a set” shall be construed in the same manner as “one or more.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
one or more memories storing processor-executable code; and
one or more processors coupled with the one or more memories and individually or collectively operable to execute the code to cause the UE to:
receive control signaling that indicates a frequency resource allocation for multiple sidelink resources, the multiple sidelink resources including at least a first sidelink resource and a second sidelink resource, wherein the frequency resource allocation indicates a non-contiguous subchannel combination for the second sidelink resource of the multiple sidelink resources; and
communicate via a sidelink channel using at least the first sidelink resource and the second sidelink resource of the multiple sidelink resources, wherein a subchannel combination for the first sidelink resource is based at least in part on a relationship between the first sidelink resource and the second sidelink resource and on a quantity of the multiple sidelink resources.

2. The UE of claim 1, wherein the control signaling indicates an index value associated with the frequency resource allocation for selecting the non-contiguous subchannel combination for the second sidelink resource, and the one or more processors are individually or collectively further operable to execute the code to cause the UE:
select the non-contiguous subchannel combination for the second sidelink resource based at least in part on the index value associated with the frequency resource allocation.

3. The UE of claim 2, wherein the one or more processors are individually or collectively further operable to execute the code to cause the UE to:
map the index value associated with the frequency resource allocation to one of a plurality of subchannel combinations, wherein selecting the non-contiguous subchannel combination for the second sidelink resource is based at least in part on mapping the index value to one of the plurality of subchannel combinations.

4. The UE of claim 2, wherein the one or more processors are individually or collectively further operable to execute the code to cause the UE to:
select the non-contiguous subchannel combination for the second sidelink resource as the subchannel combination for the first sidelink resource, wherein the relationship between the second sidelink resource and the first sidelink resource comprises the non-contiguous subchannel combination for the second sidelink resource being applied to each of the multiple sidelink resources.

5. The UE of claim 2, wherein the one or more processors are individually or collectively further operable to execute the code to cause the UE to:
select a second non-contiguous subchannel combination as the subchannel combination for the first sidelink resource, wherein the relationship between the second sidelink resource and the first sidelink resource comprises that each of the multiple sidelink resources are associated with a respective non-contiguous subchannel combination.

6. The UE of claim 5, wherein selecting the second non-contiguous subchannel combination for the first sidelink resource is based at least in part on a starting subchannel index of a PSCCH and a defined offset.

7. The UE of claim 6, wherein the one or more processors are individually or collectively further operable to execute the code to cause the UE to:
calculate a difference between a first index of a first subchannel of the non-contiguous subchannel combination for the second sidelink resource and a second index of a second subchannel of the non-contiguous subchannel combination for the second sidelink resource, wherein the defined offset is based at least in part on the difference.

8. The UE of claim 6, wherein the one or more processors are individually or collectively further operable to execute the code to cause the UE to:
receive, via the control signaling, an indication of the defined offset.

9. The UE of claim 5, wherein selecting the second non-contiguous subchannel combination is based at least in part on a starting subchannel index of a PSCCH and a quantity of subchannels indicated via the frequency resource allocation.

10. The UE of claim 9, wherein the second non-contiguous subchannel combination has a same starting subchannel index as the PSCCH and a same quantity of subchannels as the non-contiguous subchannel combination for the second sidelink resource.

11. The UE of claim 9, wherein the one or more processors are individually or collectively further operable to execute the code to cause the UE to:
receive, via the control signaling, an indication of the second non-contiguous subchannel combination for the first sidelink resource, wherein the second non-contiguous subchannel combination is selected based on the indication.

12. The UE of claim 2, wherein the subchannel combination for the first sidelink resource is a contiguous subchannel combination.

13. The UE of claim 12, wherein the one or more processors are individually or collectively further operable to execute the code to cause the UE to:
receive, via the control signaling, an indication of the contiguous subchannel combination.

14. The UE of claim 12, wherein the contiguous subchannel combination is based at least in part on a starting subchannel index of a PSCCH and a quantity of subchannels indicated via the frequency resource allocation.

15. The UE of claim 2, wherein selecting the non-contiguous subchannel combination for the second sidelink resource is further based at least in part on a starting subchannel index of a PSCCH.

16. The UE of claim 2, wherein selecting the non-contiguous subchannel combination for the second sidelink resource is further based at least in part on a quantity of subchannels for the second sidelink resource and a quantity of subchannel indexes of the non-contiguous subchannel combination for the second sidelink resource.

17. The UE of claim 2, wherein a quantity of bits of the index value of the frequency resource allocation is based at least in part on a quantity of a plurality of contiguous subchannel combinations for the multiple sidelink resources and a quantity of a plurality of non-contiguous subchannel combinations for the multiple sidelink resources.

18. A user equipment (UE) for wireless communication, comprising:
one or more memories storing processor-executable code; and
one or more processors coupled with the one or more memories and individually or collectively operable to execute the code to cause the UE to:
transmit control signaling that indicates a frequency resource allocation for multiple sidelink resources, the multiple sidelink resources including at least a first sidelink resource and a second sidelink resource, wherein the frequency resource allocation indicates a non-contiguous subchannel combination for the second sidelink resource of the multiple sidelink resources; and
communicate via a sidelink channel using at least the first sidelink resource and the second sidelink resource of the multiple sidelink resources, wherein a subchannel combination for the first sidelink resource is based at least in part on a relationship between the second sidelink resource and the first sidelink resource and on a quantity of the multiple sidelink resources.

19. The UE of claim 18, wherein the non-contiguous subchannel combination for the second sidelink resource is based at least in part on an index value of the frequency resource allocation.

20-28. (canceled)

29. A method for wireless communications by a user equipment (UE), comprising:
receiving control signaling that indicates a frequency resource allocation for multiple sidelink resources, the multiple sidelink resources including at least a first sidelink resource and a second sidelink resource, wherein the frequency resource allocation indicates a non-contiguous subchannel combination for the second sidelink resource of the multiple sidelink resources; and
communicating via a sidelink channel using at least the first sidelink resource and the second sidelink resource of the multiple sidelink resources, wherein a subchannel combination for the first sidelink resource is based at least in part on a relationship between the first sidelink resource and the second sidelink resource and on a quantity of the multiple sidelink resources.

30. (canceled)
